(19) United States
(12) Patent Application Publication
(10) Pub. No.: US 2016/0026928 A1
(43) Pub. Date: Jan. 28, 2016

(54) Automated Diagnostic

(71) Applicant: Franz Peter Liebel, Grossbettlingen (DE)

(72) Inventor: Franz Peter Liebel, Grossbettlingen (DE)

(21) Appl. No.: 14/745,407

(22) Filed: Jun. 20, 2015

(30) Foreign Application Priority Data
Jul. 25, 2014 (DE) EP 14002593

(51) Int. Cl. G06N 7/00; G06F 17/18

(52) U.S. Cl. CPC G06N 7/005; G06F 17/18

(57) ABSTRACT

State of the art was the European patent application EP 99105884.3 (see application data sheet). This patent application used already non-linear systems of equations and conditional probabilities with one single item in the condition. It was necessary, however, to perfect these theoretical methods and make them practicable. Many improvements and innovative modifications were needed. The following list identifies the innovations that had to be provided:
The accurate indication of all systems of equations concerning 2, 3 and 4 hypotheses.
Those equations can be entered in exactly the presented form into the calculation program.
The introduction of coefficients aᵢₖ and bᵢₖ that can be applied without changes for any areas of use.
The delivery of a scheme that enables the mechanized production of the aᵢₖ and bᵢₖ.
Introducing schematic tables with identical follow events in one row (e.g. Table 3).
Using appreciation factors AF(i) if the hypotheses Kᵢ′ have the same a-priori probability.
Uncomplicated approach to the causes of the causative events Kᵢ and to the inhibitors.
New factors fᵢⱼ for creating a simplification in order to allow an immediate consideration of symptoms which, although expected, did not occur.
Continuous updating of probabilities used.
No self-developed iterative methods of solution are used, but commercially available calculation programs.
A complete and workable example of the automated analysis of electrocardiograms is presented which may serve also as a design template.
The entire operation (using the calculation program selected at this point) is done with just one mouse click.

### CROSS REFERENCE TO RELATED APPLICATIONS

See application data sheet.

### STATEMENT REGARDING FEDERALLY SPONSORING

N/A

### THE NAMES OF THE PARTIES TO A JOINT RESEARCH

N/A

### REFERENCE TO A COMPACT DISC

N/A

### BACKGROUND OF THE INVENTION

According to the U.S. classification definitions, the invention belongs to Class Number 706, Data processing: artificial intelligence. It belongs as well to Class Number 708, Electrical computers: arithmetic processing and calculating. This is due to the universal usability of the invention, e.g. as a means to evaluate a patient's electrocardiogram or as a means to survey offshore wind powered electricity generators.

By using the method it becomes possible to calculate precisely the appreciation factors AF(i) or the a-posteriori probabilities xᵢ of 2, 3 or 4 hypothetical diagnoses. Required are conditional probabilities which fulfill the basic structure p(following event|causative event). It is emphasized that these conditional probabilities have only one element in the condition. The invention is equipped with a complete and workable example of a calculation program which may be used immediately and without modifications to evaluate electrocardiograms. The attached example is the clear proof that the method works well, sure, and according to mathematical principles.

### BRIEF SUMMARY OF THE INVENTION

The invention represents a universal method that can be used in numerous fields of knowledge, for example, earthquake research, geological prospecting, criminal forensics, aircraft accident investigation, on-board diagnosis in road cars and aircraft, monitoring of sea-based wind turbines and the entire field of medicine. In the latter case it is the first task to analyze electrocardiograms.

The procedure under discussion is applicable in all cases where several hypotheses stand for selection and the most likely candidate will be determined by the symptoms observed and the surrounding hypotheses. Therefore an algebraic method had to be chosen to take into account not only the symptoms but also the competing hypotheses and—according to need—the inhibitors. On mathematical basis, using the Discrete Stochastic, a method was designed to establish the systems of equations required to determine the unknown probabilities of the hypotheses.

The computer used performs the calculations, and as input it receives in the simplest and most practical case the symptoms observed or the symptoms missing, and as output it provides a list of the proposed diagnoses which are sorted according to their respective probability of existence.

### BRIEF DESCRIPTION OF THE DRAWINGS

N/A

### DETAILED DESCRIPTION OF THE INVENTION

Causal Structure

Until now it has been completely impossible during a diagnostic process to adequately consider 1) the symptoms observed, 2) the expected but non-appearing symptoms, 3) the mutual influencing of the diagnoses upon one another, and 4) the a-priori probabilities of the possible diagnoses. In order to accomplish this a technical aid is urgently needed. It is exactly this function which is fulfilled by the presented concept of a diagnostic machine which has the potential to be applied in diverse spheres of activity, and particularly in medicine.

For medical diagnostics, all diseases of an organ or part of the organ are registered and compiled with their respective symptoms. The disease to be diagnosed is selected and given the code K₁′, while any relevant differential diagnoses are encoded as K₂′, K₃′ and K₄′. In this way K′-groups are formed with four competitors, all of which are entered in the same way into the computer, as shown below with a detailed example of a K′ “foursome”.

The follow events generated from each of the K′-elements form the sets of F-elements; as such (F₁₁, . . . , F₁₆) belong to K₁′, (F₂₁, . . . , F₂₆) are attributable to K₂′, (F₃₁, . . . , F₃₆) result from K₃′ and (F₄₁, . . . , F₄₆) belong to K₄′, whereby even though the individual F-elements may be indexed differently, in many cases they may actually designate the same symptoms. In general the index i contained in Fᵢⱼ refers to the causative elements K₁′, i: =1, . . . , 4 while the index j denotes the sequential order of the symptoms, with j:=1, . . . , 6.

As an example, in the following tables 1, 2 and 3 an arbitrary causal structure is shown for K₁′. Such a causal structure is calculated, i.e. for all listed K′-elements the a-posteriori probability is determined from the respective a-priori probability.

The a-posteriori probability of an arbitrarily singled out K₁′ is influenced by the F₁ⱼ events and by the competitors (K₂′, K₃′, K₄′) since these competitors can also produce some of the F₁ⱼ. The symptom set determined in a case to be diagnosed defines which of the F-elements enter the calculations as negated or non-negated. The negated F-elements represent the previously mentioned symptoms that were expected for K₁′, but which actually could not be observed.

The mathematical actions presented in detail for K₁′ must be carried out in the same way for all the other K′-elements whereby the quantity of diagnoses marked by the superscript dash, i.e. (K₁′, K₂′, K₃′, K₄′), always remains the same. If K₅′ now becomes another differential diagnosis, the negated K₅ is then included in the K′ “foursome” and treated as such, i.e. the presence of K₅ will initially be excluded. In order to confirm the calculation result, each of such excluded diagnoses can then be raised to a primary diagnosis and provided with its own K′-grouping so that it can be calculated in the same way.

TABLE 1
Example of a causal structure to calculate K₁′. The table
contains the F₁ⱼ-elements which are caused by K₁′. It also
contains the K′-elements which may compete against K₁′
with respect to the production of the F₁ⱼ-elements.

| | K₁′ | K₂′ | K₃′ | K₄′ |
|---|---|---|---|---|
| F₁₁ | + | + | | + |
| F₁₂ | + | + | + | + |
| F₁₃ | + | + | | + |
| F₁₄ | + | | + | + |
| F₁₅ | + | | + | |
| F₁₆ | + | + | + | |

“+” indicates a causal connection between the K′-elements at the top and the F₁ⱼ-elements on the left hand side.

The Table 1 can be rearranged:

The structure shown in Table 1 and 2 is consistent with the implied structure given in Table 3 below.

{K₁′, K₂′, K₃′, K₄′}contain the sought diagnoses (K stands for “Known Competitor”). The elements have an unknown probability of existence (0<p<1) and for this reason bear a superscript dash. The number of competitors is restricted for convenience to four. If the number is increased by one additional ′-element, the length of the calculation equations for the sought unknowns is doubled.

{F₁₁, F₁₂, F₁₃, F₁₄, F₁₅, F₁₆} contains the symptoms of K₁′ (F stands for “Follow Event”). The number of the considered follow events can be freely selected and has been set here arbitrarily to six elements. The events from {F₁₁, F₁₂, F₁₃, F₁₄, F₁₅, F₁₆} are entered into the structure with the probability (p=1), but will change to (p=0) if the symptom set identifies them with this probability. In addition, any event should be removed from the set {F₁₁, F₁₂, F₁₃, F₁₄, F₁₅, F₁₆} if the following criterion is not met for this event: Each of the elements from the set {F₁₁, F₁₂, F₁₃, F₁₄, F₁₅, F₁₆}, which are induced by K₁′, should have at least one additional cause from the set {K₂′, K₃′, K₄′}.

Because of the last-mentioned criterion, it certainly makes sense to create a tabular summary for K₁′ and the Fᵢⱼ-symptoms belonging to it, supplemented by the total number of symptoms to be considered, namely S1, . . . , S9.

TABLE 3
Tabular overview and continuation of Table 1. The symptoms S1, . . . , S9 are arbitrarily
chosen. The numerical values of the p(Fᵢⱼ|Kᵢ~) are estimated values.
The tilde symbol denotes a product of events (synonymous: compound of events, logic
product) which apart from the Kᵢ entered before the tilde contains all competing
diagnoses in negated form.

| | Diagnoses | | | | | | | |
|---|---|---|---|---|---|---|---|---|
| | K₁: Acute | | K₂: Dilated | | K₃: Coronary | | K₄: Toxic | |
| | myocarditis | | cardiomyopathy | | heart disease | | cardiomyopathy | |
| Symptoms | p(F₁ⱼ\|K₁~) | | p(F₂ⱼ\|K₂~) | | p(F₃ⱼ\|K₃~) | | p(F₄ⱼ\|K₄~) | |
| S1: QRS complex | F₁₁ | 0.6 | F₂₁ | 0.6 | | | F₄₁ | 0.5 |
| >0.12 sec | | | | | | | | |
| S2: S waves, low | F₁₂ | 0.5 | F₂₂ | 0.5 | F₃₁ | 0.3 | F₄₂ | 0.3 |
| in V1 + V2 | | | | | | | | |
| S3: QRS complex | F₁₃ | 0.5 | F₂₃ | 0.5 | | | F₄₃ | 0.3 |
| split in V5 + V6 | | | | | | | | |
| S4: PQ time | F₁₄ | 0.6 | | | F₃₂ | 0.2 | F₄₄ | 0.5 |
| >0.1 sec | | | | | | | | |
| S5: RR intervals | F₁₅ | 0.9 | | | F₃₃ | 0.5 | | |
| varving | | | | | | | | |
| S6: Heart rate | F₁₆ | 0.7 | F₂₄ | 0.4 | F₃₄ | 0.4 | | |
| >100/min | | | | | | | | |
| S7: P-wave in | | | F₂₅ | 0.6 | F₃₅ | 0.6 | | |
| sawtooth shape | | | | | | | | |
| S8: ST-segment | | | F₂₆ | 0.7 | | | F₄₅ | 0.2 |
| lowered | | | | | | | | |
| S9: T-negativity | | | | | F₃₆ | 0.7 | F₄₆ | 0.4 |
| in V2 | | | | | | | | |

Design of Table 3

First, the numerical values of the probabilities p(Fᵢⱼ|Kᵢ˜) are statistically determined. For the purpose of determining these values, the i-indexing is the same for F and K.

To achieve an orderly procedure, all symptoms to be considered are recorded in the first column. For each diagnosis, an additional column is then reserved. All follow events (symptoms) of a diagnosis are entered in the column reserved for this diagnosis, along with their p(Fᵢⱼ|Kᵢ˜) numerical values, the i-indexing for F and K being the same. The ordering is to be carried out in such a way that identical follow events, i.e. events with different Fᵢⱼ indexing but the same symptom affiliation, are positioned in one row.

The numerical value, e.g. for p(F₂₆|K₄˜), can then be read off easily as zero, when nothing is entered at the intersection of the F₂₆ row and the K₄ column, or as the numerical value which has already been determined and entered for a follow event affiliated to K₄. If for instance the numerical value for p(F₄₅|K₄˜) is entered at the intersection of the F₂₆ row and the K₄ column, this value is then assumed for p(F₂₆|K₄˜), since although the two follow events F₂₆ and F₄₅ are indexed differently, they actually refer to the same symptom in the first column of the table. This symptom in this example is “ST-segment lowered”, which in this case is designated as S8.

Note 1

Table 1, 2 and 3 provide the basic structure for the calculation example at the end of the presentation. This calculation example can be used as a model framework for creating tools to make diagnostic decisions for numerous tasks in the field of medicine and outside medicine as well.

### Requirements

The elements in {K₁′, K₂′, K₃′, K₄′} are stochastically independent.
The elements in {K₁′, K₂′, K₃′, K₄′} are stochastically self-reliant causes (this means that the inhibitors of the causal pathway leading away from the K′-elements are stochastically independent and in addition they are stochastically independent with regard to the K′-elements).
{K₁′, K₂′, K₃′, K₄′} contains all events that are the cause of two or more elements from {F₁₁, F₁₂, F₁₃, F₁₄, F₁₅, F₁₆}.

Comments on the Requirements

For any two elements from {F₁₁, F₁₂, F₁₃, F₁₄, F₁₅, F₁₆} conditional stochastic independence can be achieved if the condition contains all causes which the two events have in common. If that is not the case, and if e.g. K₅′ is another cause of at least two elements from the set {F₁₁. F₁₂, F₁₃, F₁₄, F₁₅, F₁₆}, the absence of K₅′ is assumed and the negated K is then included in the causal structure and in the calculations (whereby a conceptual inclusion is sufficient).

It is also important that conditional stochastic independence will only be achieved if the causes in the condition constellation are attributed (p=1) or (p=0), but not (0<p<1), i.e. they should not have a superscript dash.

Regarding the subsequent use of inhibitors, the requirement of self-reliant causes is already dealt with here, in that the causal pathways leading from one cause to two follow events should show no interference with one another. This means that the inhibitors which act on such causal pathways must be stochastically independent.

Four Diagnoses

Calculation of x₁

The evaluation environment for K₁′ (in brief: W(K₁′)) describes a constellation of events containing those elements of the causal structure that influence the probability of existence of K₁. (W stands for “World of K₁′”) In the specified causal structure, W(K₁′) consists of the two logic products (F₁₁ F₁₂ F₁₃ F₁₄ F₁₅ F₁₆) and (K₂′ K₃′ K₄′), connected by a Boolean “and”.

The probability of existence for K₁ under the condition of the evaluation environment for K₁′, i.e. p(K₁|W(K₁′)), is the sought unknown x₁. For historical reasons, p(K₁|W(K₁′)) is given the shorter form p(K₁|K₁′). The same applies for x₂, x₃ and x₄, From this we get:

x₁:=p(K₁|W(K₁′)):=p(K₁|K₁′):=p(K₁|F₁₁ . . . F₁₆K₂′K₃′K₄).

x₂:=p(K₂|W(K₂′)):=p(K₂|K₂′):=p(K₂|F₂₁ . . . F₂₆K₁′K₃′K₄).

x₃:=p(K₃|W(K₃′)):=p(K₃|K₃′):=p(K₃|F₃₁ . . . F₃₆K₂′K₁′K₄).

x₄:=p(K₄|W(K₄′)):=p(K₄|K₄′):=p(K₄|F₄₁ . . . F₄₆K₂′K₃′K₁).

The unknown x₁:=p(K₁|F₁₁ . . . F₁₆ K₂′ K₃′ K₄′) is transformed as follows:

$${x}_{1} := p ( {K}_{1} \vert {F}_{11} … {F}_{16} {K}_{2}^{′} {K}_{3}^{′} {K}_{4}^{′} ) = \frac{p ( {K}_{1} {F}_{11} … {F}_{16} {K}_{2}^{′} {K}_{3}^{′} {K}_{4}^{′} )}{p ( {K}_{1} {F}_{11} … {F}_{16} {K}_{2}^{′} {K}_{3}^{′} {K}_{4}^{′} ) + p ( {\overline{K}}_{1} {F}_{11} … {F}_{16} {K}_{2}^{′} {K}_{3}^{′} {K}_{4}^{′} )} = \frac{1}{1 + \frac{p ( {F}_{11} … {F}_{16} {\overline{K}}_{1} {K}_{2}^{′} {K}_{3}^{′} {K}_{4}^{′} )}{p ( {F}_{11} … {F}_{16} {K}_{1} {K}_{2}^{′} {K}_{3}^{′} {K}_{4}^{′} )}} = \frac{1}{1 + \frac{p ( {F}_{11} … {F}_{16} \vert {\overline{K}}_{1} {K}_{2}^{′} {K}_{3}^{′} {K}_{4}^{′} ) p ( {\overline{K}}_{1} {K}_{2}^{′} {K}_{3}^{′} {K}_{4} )}{p ( {F}_{11} … {F}_{16} \vert {K}_{1} {K}_{2}^{′} {K}_{3}^{′} {K}_{4}^{′} ) p ( {K}_{1} {K}_{2}^{′} {K}_{3}^{′} {K}_{4} )}} = \frac{1}{1 + \frac{p ( {F}_{11} … {F}_{16} \vert {\overline{K}}_{1} {K}_{2}^{′} {K}_{3}^{′} {K}_{4}^{′} ) p ( {\overline{K}}_{1} \vert {K}_{2}^{′} {K}_{3}^{′} {K}_{4} )}{p ( {F}_{11} … {F}_{16} \vert {K}_{1} {K}_{2}^{′} {K}_{3}^{′} {K}_{4}^{′} ) p ( {K}_{1} \vert {K}_{2}^{′} {K}_{3}^{′} {K}_{4} )}} = ( independency , K - elements )$$

$$\frac{1}{1 + \frac{p ( {F}_{11} … {F}_{16} \vert {\overline{K}}_{1} {K}_{2}^{′} {K}_{3}^{′} {K}_{4}^{′} ) p ( {\overline{K}}_{1} )}{p ( {F}_{11} … {F}_{16} \vert {K}_{1} {K}_{2}^{′} {K}_{3}^{′} {K}_{4}^{′} ) p ( {K}_{1} )}} .$$

The mathematical term in the numerator, Z₁:=p(F₁ . . . F₆| K̅₁K₂′K₃′K₄′), is subjected to linear interpolation:

$$p ( {F}_{11} … {F}_{16} \vert {\overline{K}}_{1} {K}_{2}^{′} {K}_{3}^{′} {K}_{4}^{′} ) = p ( {F}_{11} … {F}_{16} \vert {\overline{K}}_{1} {K}_{2} {K}_{3} {K}_{4} ) \cdot p ( {K}_{2} \vert {K}_{2}^{′} ) \cdot p ( {K}_{3} \vert {K}_{3}^{′} ) \cdot p ( {K}_{4} \vert {K}_{4}^{′} ) + p ( {F}_{11} … {F}_{16} \vert {\overline{K}}_{1} {K}_{2} {K}_{3} {\overline{K}}_{4} ) \cdot p ( {K}_{2} \vert {K}_{2}^{′} ) \cdot p ( {K}_{3} \vert {K}_{3}^{′} ) \cdot p ( {\overline{K}}_{4} \vert {K}_{4}^{′} ) + p ( {F}_{11} … {F}_{16} \vert {\overline{K}}_{1} {K}_{2} {\overline{K}}_{3} {K}_{4} ) \cdot p ( {K}_{2} \vert {K}_{2}^{′} ) \cdot p ( {\overline{K}}_{3} \vert {K}_{3}^{′} ) \cdot p ( {K}_{4} \vert {K}_{4}^{′} ) + p ( {F}_{11} … {F}_{16} \vert {\overline{K}}_{1} {K}_{2} {\overline{K}}_{3} {\overline{K}}_{4} ) \cdot p ( {K}_{2} \vert {K}_{2}^{′} ) \cdot p ( {\overline{K}}_{3} \vert {K}_{3}^{′} ) \cdot p ( {\overline{K}}_{4} \vert {K}_{4}^{′} ) + p ( {F}_{11} … {F}_{16} \vert {\overline{K}}_{1} {\overline{K}}_{2} {K}_{3} {K}_{4} ) \cdot p ( {\overline{K}}_{2} \vert {K}_{2}^{′} ) \cdot p ( {K}_{3} \vert {K}_{3}^{′} ) \cdot p ( {K}_{4} \vert {K}_{4}^{′} ) + p ( {F}_{11} … {F}_{16} \vert {\overline{K}}_{1} {\overline{K}}_{2} {K}_{3} {\overline{K}}_{4} ) \cdot p ( {\overline{K}}_{2} \vert {K}_{2}^{′} ) \cdot p ( {K}_{3} \vert {K}_{3}^{′} ) \cdot p ( {\overline{K}}_{4} \vert {K}_{4}^{′} ) + p ( {F}_{11} … {F}_{16} \vert {\overline{K}}_{1} {\overline{K}}_{2} {\overline{K}}_{3} {K}_{4} ) \cdot p ( {\overline{K}}_{2} \vert {K}_{2}^{′} ) \cdot p ( {\overline{K}}_{3} \vert {K}_{3}^{′} ) \cdot p ( {K}_{4} \vert {K}_{4}^{′} ) + p ( {F}_{11} … {F}_{16} \vert {\overline{K}}_{1} {\overline{K}}_{2} {\overline{K}}_{3} {\overline{K}}_{4} ) \cdot p ( {\overline{K}}_{2} \vert {K}_{2}^{′} ) \cdot p ( {\overline{K}}_{3} \vert {K}_{3}^{′} ) \cdot p ( {\overline{K}}_{4} \vert {K}_{4}^{′} ) .$$

The linear interpolation for the denominator term N₁:=p(F₁₁ . . . F₁₆|K₁K₂′K₃′K₄′) is carried out in the same way, only K̅₁ is replaced by K₁.

A simplified form of notation is introduced. Defining examples are provided by

p(F₁₁|˜):=p(F₁₁| K̅₁ K̅₂ K̅₃ K̅₄) and

p(F₁₁|K₁˜):=p(F₁₁|K₁ K̅₂ K̅₃ K̅₄)

where the tilde symbol denotes a product of events (synonymous: compound of events, logic product) which apart from the Kᵢ entered before the tilde contains all competing diagnoses in negated form (see earlier definition in Table 3).

The conditional probabilities, which arise in such interpolations of Zᵢ and Nᵢ, are designated by aᵢₖ and bᵢₖ, k:=0, . . . , 7 namely aᵢₖ with the interpolations of Zᵢ and bᵢₖ with the interpolations of Nᵢ. Thus, for example, the first factor appearing after interpolation of Z₁ is replaced by a₁₀ with

a₁₀:=p(F₁₁ . . . F₁₆| K̅₁K₂K₃K₄).

A factorization with respect to the F-elements then follows:

a₁₀:=p(F₁₁| K̅₁K₂K₃K₄)· . . . ·p(F₁₆| K̅₁K₂K₃K₄).

The factorization is made possible by the fact that the logic product of events ( K̅₁K₂K₃K₄) contains all causes of {F₁₁, . . . , F₁₆}, so that the conditional stochastic independence of the F-elements is reached.

Note 2 The factorization with respect to the F-elements takes place after the interpolation.

Next, the factorization with respect to the K-elements takes place, e.g. the factorization of expressions of the form p(F₁₁| K̅₁K₂K₃K₄). To achieve this, the theorem p( F̅₁₁| K̅₁K₂K₃K₄):=p( F̅₁₁|K₂˜)·p( F̅₁₁|K₃˜)·p( F̅₁₁|K₄˜) is used. The theorem holds because the members from {K₁, K₂, K₃, K₄} are assumed to be stochastically self-reliant causes of F₁₁.

This results in:

$$\begin{matrix}{a}_{10} := \\ p ( {F}_{11} … {F}_{16} \vert {\overline{K}}_{1} {K}_{2} {K}_{3} {K}_{4} ) = \\ p ( {F}_{11} \vert {\overline{K}}_{1} {K}_{2} {K}_{3} {K}_{4} ) \cdot … \cdot p ( {F}_{16} \vert {\overline{K}}_{1} {K}_{2} {K}_{3} {K}_{4} ) = \\ [ 1 - p ( {\overline{F}}_{11} \vert {\overline{K}}_{1} {K}_{2} {\overline{K}}_{3} {\overline{K}}_{4} ) \cdot p ( {\overline{F}}_{11} \vert {\overline{K}}_{1} {\overline{K}}_{2} {K}_{3} {\overline{K}}_{4} ) \cdot p ( {\overline{F}}_{11} \vert {\overline{K}}_{1} {\overline{K}}_{2} {\overline{K}}_{3} {K}_{4} ) ] \cdot \\ ⋮ \\ \cdot [ 1 - p ( {\overline{F}}_{16} \vert {\overline{K}}_{1} {K}_{2} {\overline{K}}_{3} {\overline{K}}_{4} ) \cdot p ( {\overline{F}}_{16} \vert {\overline{K}}_{1} {\overline{K}}_{2} {K}_{3} {\overline{K}}_{4} ) \cdot p ( {\overline{F}}_{16} \vert {\overline{K}}_{1} {\overline{K}}_{2} {\overline{K}}_{3} {K}_{4} ) ] = \\ [ 1 - p ( {\overline{F}}_{11} \vert {K}_{2} ∼ ) \cdot p ( {\overline{F}}_{11} \vert {K}_{3} ∼ ) \cdot p ( {\overline{F}}_{11} \vert {K}_{4} ∼ ) ] \cdot \\ ⋮ \\ \cdot [ 1 - p ( {\overline{F}}_{16} \vert {K}_{2} ∼ ) \cdot p ( {\overline{F}}_{16} \vert {K}_{3} ∼ ) \cdot p ( {\overline{F}}_{16} \vert {K}_{4} ∼ ) ] ;\end{matrix}$$

Note 3

In the requirements it was merely demanded that the set {K₁′, K₂′, K₃′, K₄′}contains those K′-events that induce two or more F-elements. Accordingly, outside the set {K₁′, K₂′, K₃′, K₄′}other causes of F-elements might exist that induce only a single F-element. Then the theorem “factorization in case of hidden causes” is applied, which generates for the exemplary probability p(F₁₁|K₁K₂K₃K₄) the following:

$$p ( {F}_{11} \vert {\overline{K}}_{1} {K}_{2} {K}_{3} {K}_{4} ) = 1 - \frac{p ( {\overline{F}}_{11} \vert {\overline{K}}_{1} {K}_{2} {\overline{K}}_{3} {\overline{K}}_{4} ) \cdot p ( {\overline{F}}_{11} \vert {\overline{K}}_{1} {\overline{K}}_{2} {K}_{3} {\overline{K}}_{4} ) \cdot p ( {\overline{F}}_{11} \vert {\overline{K}}_{1} {\overline{K}}_{2} {\overline{K}}_{3} {K}_{4} )}{{p ( {\overline{F}}_{11} \vert {\overline{K}}_{1} {\overline{K}}_{2} {\overline{K}}_{3} {\overline{K}}_{4} )}^{2}} = 1 - \frac{p ( {\overline{F}}_{11} \vert {K}_{2} ∼ ) \cdot p ( {\overline{F}}_{11} \vert {K}_{3} ∼ ) \cdot p ( {\overline{F}}_{11} \vert {K}_{4} ∼ )}{{p ( {\overline{F}}_{11} \vert ∼ )}^{2}}$$

Note 4

For practical purposes p(F₁₁|˜):=0 is set. This is just a preliminary arrangement, which can be revoked at any time for the purposes of improving precision. (In addition, since the hidden cause that might exist creates only one F-element, the conditional stochastic independence of the F-elements is not violated.)

Note 5

Also consider that for any Fᵢⱼ and any Kᵢ the expression p(Fᵢⱼ|Kᵢ˜):=0 always applies if Fᵢⱼ does not have Kᵢ as a cause. For example, in the previous calculation of a₁₀ there appears p(F₁₁| K̅₁K₂K₃K₄) which could be zero if F₁₁ is only caused by K₁ and neither by K₂ nor K₃ nor K₄. However, this possibility is excluded by the requirement that each Fᵢⱼ must be caused by at least two K′-elements.

After linear interpolation of Z₁, the other members from {a₁ₖ, k:=0, . . . , 7} are determined to:

$$\begin{matrix}{a}_{11} := \\ p ( {F}_{11} … {F}_{16} \vert {\overline{K}}_{1} {K}_{2} {K}_{3} {\overline{K}}_{4} ) = \\ p ( {F}_{11} \vert {\overline{K}}_{1} {K}_{2} {K}_{3} {\overline{K}}_{4} ) \cdot … \cdot p ( {F}_{16} \vert {\overline{K}}_{1} {K}_{2} {K}_{3} {\overline{K}}_{4} ) = \\ [ 1 - p ( {\overline{F}}_{11} \vert {\overline{K}}_{1} {K}_{2} {\overline{K}}_{3} {\overline{K}}_{4} ) \cdot p ( {\overline{F}}_{11} \vert {\overline{K}}_{1} {\overline{K}}_{2} {K}_{3} {\overline{K}}_{4} ) ] \cdot \\ ⋮ \\ \cdot [ 1 - p ( {\overline{F}}_{16} \vert {\overline{K}}_{1} {K}_{2} {\overline{K}}_{3} {\overline{K}}_{4} ) \cdot p ( {\overline{F}}_{16} \vert {\overline{K}}_{1} {\overline{K}}_{2} {K}_{3} {\overline{K}}_{4} ) ] = \\ [ 1 - p ( {\overline{F}}_{11} \vert {K}_{2} ∼ ) \cdot p ( {\overline{F}}_{11} \vert {K}_{3} ∼ ) ] \cdot … \cdot \\ [ 1 - p ( {\overline{F}}_{16} \vert {K}_{2} ∼ ) \cdot p ( {\overline{F}}_{16} \vert {K}_{3} ∼ ) ] ;\end{matrix} \\ \begin{matrix}{a}_{12} := \\ p ( {F}_{11} … {F}_{16} \vert {\overline{K}}_{1} {K}_{2} {\overline{K}}_{3} {K}_{4} ) = \\ p ( {F}_{11} \vert {\overline{K}}_{1} {K}_{2} {\overline{K}}_{3} {K}_{4} ) \cdot … \cdot p ( {F}_{16} \vert {\overline{K}}_{1} {K}_{2} {\overline{K}}_{3} {K}_{4} ) = \\ [ 1 - p ( {\overline{F}}_{11} \vert {\overline{K}}_{1} {K}_{2} {\overline{K}}_{3} {\overline{K}}_{4} ) \cdot p ( {\overline{F}}_{11} \vert {\overline{K}}_{1} {\overline{K}}_{2} {\overline{K}}_{3} {K}_{4} ) ] \cdot \\ ⋮ \\ \cdot [ 1 - p ( {\overline{F}}_{16} \vert {\overline{K}}_{1} {K}_{2} {\overline{K}}_{3} {\overline{K}}_{4} ) \cdot p ( {\overline{F}}_{16} \vert {\overline{K}}_{1} {\overline{K}}_{2} {\overline{K}}_{3} {K}_{4} ) ] = \\ [ 1 - p ( {\overline{F}}_{11} \vert {K}_{2} ∼ ) \cdot p ( {\overline{F}}_{11} \vert {K}_{4} ∼ ) ] \cdot … \cdot \\ [ 1 - p ( {\overline{F}}_{16} \vert {K}_{2} ∼ ) \cdot p ( {\overline{F}}_{16} \vert {K}_{4} ∼ ) ] ;\end{matrix} \\ \begin{matrix}{a}_{13} := \\ p ( {F}_{11} … {F}_{16} \vert {\overline{K}}_{1} {K}_{2} {\overline{K}}_{3} {\overline{K}}_{4} ) = \\ p ( {F}_{11} \vert {\overline{K}}_{1} {K}_{2} {\overline{K}}_{3} {\overline{K}}_{4} ) \cdot … \cdot p ( {F}_{16} \vert {\overline{K}}_{1} {K}_{2} {\overline{K}}_{3} {\overline{K}}_{4} ) = \\ p ( {F}_{11} \vert {K}_{2} ∼ ) \cdot … \cdot p ( {F}_{16} \vert {K}_{2} ∼ ) ;\end{matrix} \\ \begin{matrix}{a}_{14} := \\ p ( {F}_{11} … {F}_{16} \vert {\overline{K}}_{1} {\overline{K}}_{2} {K}_{3} {K}_{4} ) = \\ p ( {F}_{11} \vert {\overline{K}}_{1} {\overline{K}}_{2} {K}_{3} {K}_{4} ) \cdot … \cdot p ( {F}_{16} \vert {\overline{K}}_{1} {\overline{K}}_{2} {K}_{3} {K}_{4} ) = \\ [ 1 - p ( {\overline{F}}_{11} \vert {\overline{K}}_{1} {\overline{K}}_{2} {K}_{3} {\overline{K}}_{4} ) \cdot p ( {\overline{F}}_{11} \vert {\overline{K}}_{1} {\overline{K}}_{2} {\overline{K}}_{3} {K}_{4} ) ] \cdot \\ ⋮ \\ \cdot [ 1 - p ( {\overline{F}}_{16} \vert {\overline{K}}_{1} {\overline{K}}_{2} {K}_{3} {\overline{K}}_{4} ) \cdot p ( {\overline{F}}_{16} \vert {\overline{K}}_{1} {\overline{K}}_{2} {\overline{K}}_{3} {K}_{4} ) ] = \\ [ 1 - p ( {\overline{F}}_{11} \vert {K}_{3} ∼ ) \cdot p ( {\overline{F}}_{11} \vert {K}_{4} ∼ ) ] \cdot … \cdot \\ [ 1 - p ( {\overline{F}}_{16} \vert {K}_{3} ∼ ) \cdot p ( {\overline{F}}_{16} \vert {K}_{4} ∼ ) ] ;\end{matrix} \\ \begin{matrix}{a}_{15} := \\ p ( {F}_{11} … {F}_{16} \vert {\overline{K}}_{1} {\overline{K}}_{2} {K}_{3} {\overline{K}}_{4} ) = \\ p ( {F}_{11} \vert {\overline{K}}_{1} {\overline{K}}_{2} {K}_{3} {\overline{K}}_{4} ) \cdot … \cdot p ( {F}_{16} \vert {\overline{K}}_{1} {\overline{K}}_{2} {K}_{3} {\overline{K}}_{4} ) = \\ p ( {F}_{11} \vert {K}_{3} ∼ ) \cdot … \cdot p ( {F}_{16} \vert {K}_{3} ∼ ) ;\end{matrix} \\ \begin{matrix}{a}_{16} := \\ p ( {F}_{11} … {F}_{16} \vert {\overline{K}}_{1} {\overline{K}}_{2} {\overline{K}}_{3} {K}_{4} ) = \\ p ( {F}_{11} \vert {\overline{K}}_{1} {\overline{K}}_{2} {\overline{K}}_{3} {K}_{4} ) \cdot … \cdot p ( {F}_{16} \vert {\overline{K}}_{1} {\overline{K}}_{2} {\overline{K}}_{3} {K}_{4} ) = \\ p ( {F}_{11} \vert {K}_{4} ∼ ) \cdot … \cdot p ( {F}_{16} \vert {K}_{4} ∼ ) ;\end{matrix} \\ \begin{matrix}{a}_{17} := \\ p ( {F}_{11} … {F}_{16} \vert {\overline{K}}_{1} {\overline{K}}_{2} {\overline{K}}_{3} {\overline{K}}_{4} ) = \\ p ( {F}_{11} \vert ∼ ) \cdot … \cdot p ( {F}_{16} \vert ∼ ) .\end{matrix}$$

With the coefficients a₁₀ to a₁₇ we obtain for Z₁:=p(F₁₁ . . . F₁₆| K̅₁K₂′K₃′K₄′):

Z₁:=p(F₁₁ . . . F₁₆| K̅₁,K₂′K₃′K₄′)=a₁₀x₂x₃x₄+a₁₁x₂x₃ x̅₄+a₁₂x₂x₃ x̅₄+a₁₃x₂ x̅₃ x̅₄+a₁₄ x̅₂x₃x₄+a₁₅ x̅₂x₃ x̅₄+a₁₆ x̅₂ x̅₃x₄+a₁₇ x̅₂ x̅₃ x̅₄.

### Schematic Formation of the Coefficients aᵢₖ and bᵢₖ

For the Kᵢ′-foursome grouping and any xᵢ we have

$${x}_{i} := \frac{1}{1 + \frac{{Z}_{i}}{{N}_{i}} \cdot \frac{p ( {\overline{K}}_{i} )}{p ( {K}_{i} )}} ,$$

i:=1, . . . , 4, with

Z₁:=p(F₁₁ . . . F₁₆| K̅₁K₂′K₃′K₄′) and N₁:=p(F₁₁ . . . F₁₆|K₁K₂′K₃′K₄′),

Z₂:=p(F₂₁ . . . F₂₆| K̅₁K₂′K₃′K₄′) and N₃:=p(F₂₁ . . . F₂₆|K₂K₁′K₃′K₄′),

Z₃:=p(F₃₁ . . . F₃₆| K̅₃K₂′K₁′K₄′) and N₃:=p(F₃₁ . . . F₃₆|K₃K₂′K₁′K₄′),

Z₄:=p(F₄₁ . . . F₄₆| K̅₄K₂′K₃′K₁′) and N₄:=p(F₄₁ . . . F₄₆|K₄K₂′K₃′K₁′).

As an example we choose Z₁:=p(F₁₁ . . . F₁₆| K̅₁K₂′K₃′K₄′) to demonstrate the formation of the coefficients aᵢₖ.

Step 1:

For any aᵢₖ, e.g. for a₁₄, the number k situated in the index of aᵢₖ (here it has the value 4) is written as the binary number (100).

Step 2:

The binary number (100) is right-aligned projected onto the apostrophized elements in p(F₁₁ . . . F₁₆| K̅₁K₂′K₃′K₄′) that results to

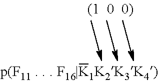

whereby the apostrophes are then omitted, and the digits “1” of the binary numbers indicate the negations to be executed; in the example it leads to

a₁₄:=p(F₁₁ . . . F₁₆| K̅₁ K̅₂K₃K₄).

Step 3:

It follows a factorization with respect to the F-elements:

p(F₁₁ . . . F₁₆| K̅₁ K̅₂K₃K₄)=p(F₁₁| K̅₁ K̅₂K₃K₄)·. . . ·p(F₁₆| K̅₁ K̅₂K₃K₄).

This is followed by a factorization with respect to the K-elements. For this purpose, a simple pattern can be used, for example

p(F₁₁| K̅₁ K̅₂K₃K₄):=1−p( F̅₁₁| K̅₁˜)·p( F̅₁₁| K̅₂˜)·p( F̅₁₁| K̅₃˜)·p( F̅₁₁| K̅₄˜)

which due to p(Fᵢⱼ|˜]:=0 is shortened to

p(F₁₁| K̅₁ K̅₂K₃K₄):=1−p( F̅₁₁|K₃˜)·p( F̅₁₁|K₄˜).

Step 4:

The coefficient a₁₄ belongs to a product of unknowns. The individual elements of this product have the same negations and indices as those obtained in Step 2, i.e. the projection is continued directly to

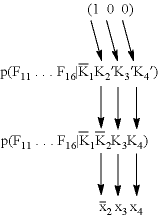

The determined ( x̅₂x₃x₄) is the product of unknowns associated with the coefficient a₁₄.

Result:

a₁₄ x̅₂x₃x₄=[1−p( F̅₁₁|K₃ . . . )·p( F̅₁₁|K₄ . . . )]· . . . ·[1−p( F̅₁₆|K₃ . . . )·p( F̅₁₆|K₄ . . . )]· x̅₂x₃x₄.

Completely in line with this approach, i.e. after linear interpolation of Nᵢ or the application of the above scheme upon N₁, the coefficients b₁ₖ, k:=0, . . . , 7 are formed, thus resulting in the following:

$${N}_{1} := p ( {F}_{11} … {F}_{16} \vert {K}_{1} {K}_{2}^{′} {K}_{3}^{′} {K}_{4}^{′} ) = {b}_{10} {x}_{2} {x}_{3} {x}_{4} + {b}_{11} {x}_{2} {x}_{3} {\overline{x}}_{4} + {b}_{12} {x}_{2} {\overline{x}}_{3} {x}_{4} + {b}_{13} {x}_{2} {\overline{x}}_{3} {\overline{x}}_{4} + {b}_{14} {\overline{x}}_{2} {x}_{3} {x}_{4} + {b}_{15} {\overline{x}}_{2} {x}_{3} {\overline{x}}_{4} + {b}_{16} {\overline{x}}_{2} {\overline{x}}_{3} {x}_{4} + {b}_{17} {\overline{x}}_{2} {\overline{x}}_{3} {\overline{x}}_{4} . \\ \begin{matrix}{b}_{10} := \\ p ( {F}_{11} … {F}_{16} \vert {K}_{1} {K}_{2} {K}_{3} {K}_{4} ) = \\ p ( {F}_{11} \vert {K}_{1} {K}_{2} {K}_{3} {K}_{4} ) \cdot … \cdot p ( {F}_{16} \vert {K}_{1} {K}_{2} {K}_{3} {K}_{4} ) = \\ [ 1 - p ( {\overline{F}}_{11} \vert {K}_{1} {\overline{K}}_{2} {\overline{K}}_{3} {\overline{K}}_{4} ) \cdot p ( {\overline{F}}_{11} \vert {\overline{K}}_{1} {K}_{2} {\overline{K}}_{3} {\overline{K}}_{4} ) \cdot p ( {\overline{F}}_{11} \vert {\overline{K}}_{1} {\overline{K}}_{2} {K}_{3} {\overline{K}}_{4} ) \cdot \\ p ( {\overline{F}}_{11} \vert {\overline{K}}_{1} {\overline{K}}_{2} {\overline{K}}_{3} {K}_{4} ) ] \cdot \\ ⋮ \\ \cdot [ 1 - p ( {\overline{F}}_{16} \vert {K}_{1} {\overline{K}}_{2} {\overline{K}}_{3} {\overline{K}}_{4} ) \cdot p ( {\overline{F}}_{16} \vert {\overline{K}}_{1} {K}_{2} {\overline{K}}_{3} {\overline{K}}_{4} ) \cdot p ( {\overline{F}}_{16} \vert {\overline{K}}_{1} {\overline{K}}_{2} {K}_{3} {\overline{K}}_{4} ) \cdot \\ p ( {\overline{F}}_{16} \vert {\overline{K}}_{1} {\overline{K}}_{2} {\overline{K}}_{3} {K}_{4} ) ] = \\ [ 1 - p ( {\overline{F}}_{11} \vert {K}_{1} ∼ ) \cdot p ( {\overline{F}}_{11} \vert {K}_{2} ∼ ) \cdot p ( {\overline{F}}_{11} \vert {K}_{3} ∼ ) \cdot p ( {\overline{F}}_{11} \vert {K}_{4} ∼ ) ] \cdot \\ ⋮ \\ \cdot [ 1 - p ( {\overline{F}}_{16} \vert {K}_{1} ∼ ) \cdot p ( {\overline{F}}_{16} \vert {K}_{2} ∼ ) \cdot p ( {\overline{F}}_{16} \vert {K}_{3} ∼ ) \cdot p ( {\overline{F}}_{16} \vert {K}_{4} ∼ ) ] ;\end{matrix}$$

$$\begin{matrix}{b}_{11} := \\ p ( {F}_{11} … {F}_{16} \vert {K}_{1} {K}_{2} {K}_{3} {\overline{K}}_{4} ) = \\ p ( {F}_{11} \vert {K}_{1} {K}_{2} {K}_{3} {\overline{K}}_{4} ) \cdot … \cdot p ( {F}_{16} \vert {K}_{1} {K}_{2} {K}_{3} {\overline{K}}_{4} ) = \\ [ 1 - p ( {\overline{F}}_{11} \vert {K}_{1} {\overline{K}}_{2} {\overline{K}}_{3} {\overline{K}}_{4} ) \cdot p ( {\overline{F}}_{11} \vert {\overline{K}}_{1} {K}_{2} {\overline{K}}_{3} {\overline{K}}_{4} ) \cdot p ( {\overline{F}}_{11} \vert {\overline{K}}_{1} {\overline{K}}_{2} {K}_{3} {\overline{K}}_{4} ) ] \cdot \\ ⋮ \\ \cdot [ 1 - p ( {\overline{F}}_{16} \vert {K}_{1} {\overline{K}}_{2} {\overline{K}}_{3} {\overline{K}}_{4} ) \cdot p ( {\overline{F}}_{16} \vert {\overline{K}}_{1} {K}_{2} {\overline{K}}_{3} {\overline{K}}_{4} ) \cdot \\ p ( {\overline{F}}_{16} \vert {\overline{K}}_{1} {\overline{K}}_{2} {K}_{3} {\overline{K}}_{4} ) ] = \\ [ 1 - p ( {\overline{F}}_{11} \vert {K}_{1} ∼ ) \cdot p ( {\overline{F}}_{11} \vert {K}_{2} ∼ ) \cdot p ( {\overline{F}}_{11} \vert {K}_{3} ∼ ) ] \cdot \\ ⋮ \\ \cdot [ 1 - p ( {\overline{F}}_{16} \vert {K}_{1} ∼ ) \cdot p ( {\overline{F}}_{16} \vert {K}_{2} ∼ ) \cdot p ( {\overline{F}}_{16} \vert {K}_{3} ∼ ) ] ;\end{matrix}$$

$$\begin{matrix}{b}_{12} := \\ p ( {F}_{11} … {F}_{16} \vert {K}_{1} {K}_{2} {\overline{K}}_{3} {K}_{4} ) = \\ p ( {F}_{11} \vert {K}_{1} {K}_{2} {\overline{K}}_{3} {K}_{4} ) \cdot … \cdot p ( {F}_{16} \vert {K}_{1} {K}_{2} {\overline{K}}_{3} {K}_{4} ) = \\ [ 1 - p ( {\overline{F}}_{11} \vert {K}_{1} {\overline{K}}_{2} {\overline{K}}_{3} {\overline{K}}_{4} ) \cdot p ( {\overline{F}}_{11} \vert {\overline{K}}_{1} {K}_{2} {\overline{K}}_{3} {\overline{K}}_{4} ) \cdot p ( {\overline{F}}_{11} \vert {\overline{K}}_{1} {\overline{K}}_{2} {\overline{K}}_{3} {K}_{4} ) ] \cdot \\ ⋮ \\ \cdot [ 1 - p ( {\overline{F}}_{16} \vert {K}_{1} {\overline{K}}_{2} {\overline{K}}_{3} {\overline{K}}_{4} ) \cdot p ( {\overline{F}}_{16} \vert {\overline{K}}_{1} {K}_{2} {\overline{K}}_{3} {\overline{K}}_{4} ) \cdot \\ p ( {\overline{F}}_{16} \vert {\overline{K}}_{1} {\overline{K}}_{2} {\overline{K}}_{3} {K}_{4} ) ] = \\ [ 1 - p ( {\overline{F}}_{11} \vert {K}_{1} ∼ ) \cdot p ( {\overline{F}}_{11} \vert {K}_{2} ∼ ) \cdot p ( {\overline{F}}_{11} \vert {K}_{3} ∼ ) ] \cdot \\ ⋮ \\ \cdot [ 1 - p ( {\overline{F}}_{16} \vert {K}_{1} ∼ ) \cdot p ( {\overline{F}}_{16} \vert {K}_{2} ∼ ) \cdot p ( {\overline{F}}_{16} \vert {K}_{4} ∼ ) ] ;\end{matrix}$$

$$\begin{matrix}{b}_{13} := \\ p ( {F}_{11} … {F}_{16} \vert {K}_{1} {K}_{2} {\overline{K}}_{3} {\overline{K}}_{4} ) = \\ p ( {F}_{11} \vert {K}_{1} {K}_{2} {\overline{K}}_{3} {\overline{K}}_{4} ) \cdot … \cdot p ( {F}_{16} \vert {K}_{1} {K}_{2} {\overline{K}}_{3} {\overline{K}}_{4} ) = \\ [ 1 - p ( {\overline{F}}_{11} \vert {K}_{1} {\overline{K}}_{2} {\overline{K}}_{3} {\overline{K}}_{4} ) \cdot p ( {\overline{F}}_{11} \vert {\overline{K}}_{1} {K}_{2} {\overline{K}}_{3} {\overline{K}}_{4} ) ] \cdot \\ ⋮ \\ \cdot [ 1 - p ( {\overline{F}}_{16} \vert {K}_{1} {\overline{K}}_{2} {\overline{K}}_{3} {\overline{K}}_{4} ) \cdot p ( {\overline{F}}_{16} \vert {\overline{K}}_{1} {K}_{2} {\overline{K}}_{3} {\overline{K}}_{4} ) ] = \\ [ 1 - p ( {\overline{F}}_{11} \vert {K}_{1} ∼ ) \cdot p ( {\overline{F}}_{11} \vert {K}_{2} ∼ ) ] \cdot … \cdot \\ [ 1 - p ( {\overline{F}}_{16} \vert {K}_{1} ∼ ) \cdot p ( {\overline{F}}_{16} \vert {K}_{2} ∼ ) ] ;\end{matrix}$$

$$\begin{matrix}{b}_{14} := \\ p ( {F}_{11} … {F}_{16} \vert {K}_{1} {\overline{K}}_{2} {K}_{3} {K}_{4} ) = \\ p ( {F}_{11} \vert {K}_{1} {\overline{K}}_{2} {K}_{3} {K}_{4} ) \cdot … \cdot p ( {F}_{16} \vert {K}_{1} {\overline{K}}_{2} {K}_{3} {K}_{4} ) = \\ [ 1 - p ( {\overline{F}}_{11} \vert {K}_{1} {\overline{K}}_{2} {\overline{K}}_{3} {\overline{K}}_{4} ) \cdot p ( {\overline{F}}_{11} \vert {\overline{K}}_{1} {\overline{K}}_{2} {K}_{3} {\overline{K}}_{4} ) \cdot p ( {\overline{F}}_{11} \vert {\overline{K}}_{1} {\overline{K}}_{2} {\overline{K}}_{3} {K}_{4} ) ] \cdot \\ ⋮ \\ \cdot [ 1 - p ( {\overline{F}}_{16} \vert {K}_{1} {\overline{K}}_{2} {\overline{K}}_{3} {\overline{K}}_{4} ) \cdot p ( {\overline{F}}_{16} \vert {\overline{K}}_{1} {\overline{K}}_{2} {K}_{3} {\overline{K}}_{4} ) \cdot \\ p ( {\overline{F}}_{16} \vert {\overline{K}}_{1} {\overline{K}}_{2} {\overline{K}}_{3} {K}_{4} ) ] = \\ [ 1 - p ( {\overline{F}}_{11} \vert {K}_{1} ∼ ) \cdot p ( {\overline{F}}_{11} \vert {K}_{3} ∼ ) \cdot p ( {\overline{F}}_{11} \vert {K}_{4} ∼ ) ] \cdot \\ ⋮ \\ \cdot [ 1 - p ( {\overline{F}}_{16} \vert {K}_{1} ∼ ) \cdot p ( {\overline{F}}_{16} \vert {K}_{3} ∼ ) \cdot p ( {\overline{F}}_{16} \vert {K}_{4} ∼ ) ] ;\end{matrix}$$

$$\begin{matrix}{b}_{15} := \\ p ( {F}_{11} … {F}_{16} \vert {K}_{1} {\overline{K}}_{2} {K}_{3} {\overline{K}}_{4} ) = \\ p ( {F}_{11} \vert {K}_{1} {\overline{K}}_{2} {K}_{3} {\overline{K}}_{4} ) \cdot … \cdot p ( {F}_{16} \vert {K}_{1} {\overline{K}}_{2} {K}_{3} {\overline{K}}_{4} ) = \\ [ 1 - p ( {\overline{F}}_{11} \vert {K}_{1} {\overline{K}}_{2} {\overline{K}}_{3} {\overline{K}}_{4} ) \cdot p ( {\overline{F}}_{11} \vert {\overline{K}}_{1} {\overline{K}}_{2} {K}_{3} {\overline{K}}_{4} ) ] \cdot \\ ⋮ \\ \cdot [ 1 - p ( {\overline{F}}_{16} \vert {K}_{1} {\overline{K}}_{2} {\overline{K}}_{3} {\overline{K}}_{4} ) \cdot p ( {\overline{F}}_{16} \vert {\overline{K}}_{1} {\overline{K}}_{2} {K}_{3} {\overline{K}}_{4} ) ] = \\ [ 1 - p ( {\overline{F}}_{11} \vert {K}_{1} ∼ ) \cdot p ( {\overline{F}}_{11} \vert {K}_{3} ∼ ) ] \cdot … \cdot \\ [ 1 - p ( {\overline{F}}_{16} \vert {K}_{1} ∼ ) \cdot p ( {\overline{F}}_{16} \vert {K}_{3} ∼ ) ] ;\end{matrix}$$

$$\begin{matrix}{b}_{16} := \\ p ( {F}_{11} … {F}_{16} \vert {K}_{1} {\overline{K}}_{2} {\overline{K}}_{3} {K}_{4} ) = \\ p ( {F}_{11} \vert {K}_{1} {\overline{K}}_{2} {\overline{K}}_{3} {K}_{4} ) \cdot … \cdot p ( {F}_{16} \vert {K}_{1} {\overline{K}}_{2} {\overline{K}}_{3} {K}_{4} ) = \\ [ 1 - p ( {\overline{F}}_{11} \vert {K}_{1} {\overline{K}}_{2} {\overline{K}}_{3} {\overline{K}}_{4} ) \cdot p ( {\overline{F}}_{11} \vert {\overline{K}}_{1} {\overline{K}}_{2} {\overline{K}}_{3} {K}_{4} ) ] \cdot \\ ⋮ \\ \cdot [ 1 - p ( {\overline{F}}_{16} \vert {K}_{1} {\overline{K}}_{2} {\overline{K}}_{3} {\overline{K}}_{4} ) \cdot p ( {\overline{F}}_{16} \vert {\overline{K}}_{1} {\overline{K}}_{2} {\overline{K}}_{3} {K}_{4} ) ] = \\ [ 1 - p ( {\overline{F}}_{11} \vert {K}_{1} ∼ ) \cdot p ( {\overline{F}}_{11} \vert {K}_{4} ∼ ) ] \cdot … \cdot \\ [ 1 - p ( {\overline{F}}_{16} \vert {K}_{1} ∼ ) \cdot p ( {\overline{F}}_{16} \vert {K}_{4} ∼ ) ] ;\end{matrix}$$

$$\begin{matrix}{b}_{17} := \\ p ( {F}_{11} … {F}_{16} \vert {K}_{1} {\overline{K}}_{2} {\overline{K}}_{3} {\overline{K}}_{4} ) = \\ p ( {F}_{11} \vert {K}_{1} {\overline{K}}_{2} {\overline{K}}_{3} {\overline{K}}_{4} ) \cdot … \cdot p ( {F}_{16} \vert {K}_{1} {\overline{K}}_{2} {\overline{K}}_{3} {\overline{K}}_{4} ) = \\ p ( {F}_{11} \vert {K}_{1} ∼ ) \cdot … \cdot p ( {F}_{16} \vert {K}_{1} ∼ ) .\end{matrix}$$

Note 6

In the transformation set out below it can be seen how the a-priori probabilities, e.g. p(K₁), get an upgrade.

$$p ( {K}_{1} \vert {F}_{11} … {F}_{16} {K}_{2}^{′} {K}_{3}^{′} {K}_{4}^{′} ) = \frac{p ( {F}_{11} … {F}_{16} {K}_{1} {K}_{2}^{′} {K}_{3}^{′} {K}_{4}^{′} )}{p ( {F}_{11} … {F}_{16} {K}_{2}^{′} {K}_{3}^{′} {K}_{4}^{′} )} = \frac{p ( {F}_{11} … {F}_{16} \vert {K}_{1} {K}_{2}^{′} {K}_{3}^{′} {K}_{4}^{′} ) \cdot p ( {K}_{1} {K}_{2}^{′} {K}_{3}^{′} {K}_{4}^{′} )}{p ( {F}_{11} … {F}_{16} {K}_{2}^{′} {K}_{3}^{′} {K}_{4}^{′} )} = \frac{p ( {F}_{11} … {F}_{16} \vert {K}_{1} {K}_{2}^{′} {K}_{3}^{′} {K}_{4}^{′} )}{p ( {F}_{11} … {F}_{16} \vert {K}_{2}^{′} {K}_{3}^{′} {K}_{4}^{′} )} \cdot p ( {K}_{1} \vert {K}_{2}^{′} {K}_{3}^{′} {K}_{4}^{′} ) = [ \frac{p ( {F}_{11} … {F}_{16} \vert {K}_{1} {K}_{2}^{′} {K}_{3}^{′} {K}_{4}^{′} )}{p ( {F}_{11} … {F}_{16} \vert {K}_{2}^{′} {K}_{3}^{′} {K}_{4}^{′} )} ] \cdot p ( {K}_{1} ) .$$

Now it can be seen immediately that the a-priori probability p(Kᵢ) gets an upgrade by the appreciation factor

$$AF ( 1 ) := \frac{{x}_{1}}{p ( {K}_{1} )} = [ \frac{p ( {F}_{1} … {F}_{6} \vert {K}_{1} {K}_{2}^{′} {K}_{3}^{′} {K}_{4}^{′} )}{p ( {F}_{1} … {F}_{6} \vert {K}_{2}^{′} {K}_{3}^{′} {K}_{4}^{′} )} ] .$$

Note 7

Generally, the appreciation factor AF(i) shows by what factor the a-priori probability p(Kᵢ) changes, and it thus measures the influence of the evaluation environment W(Kᵢ′) upon the probability of existence of Kᵢ′, stating a veritable numerical value.

Note 8

The term p(F₁₁ . . . F₁₆|K₂′K₃′K₄′) in the denominator of the equation above can—after linear interpolation—not be factorized with respect to the F-elements, because the condition does not contain all causes of the F-elements; an expansion is therefore required as it was performed for x₁ at the very beginning.

Initially, equiprobability is assumed for all K′-elements, i.e. the a-priori probabilities p(Kᵢ), i:=1, . . . , 4 are set to p(Kᵢ): =0.25. After performing the calculations, i.e. when the a-posteriori probabilities xᵢ, i:=1, . . . , 4 are available, the appreciation factors

$$AF ( i ) = \frac{{x}_{1}}{p ( {K}_{i} )}$$

can be formed, whereby AF(i)<1 represents a downgrading and AF(i)>1 an upgrading. The highest appreciation factor indicates that diagnosis for which the probability has risen most clearly, and which therefore becomes the first and foremost to be considered as the cause for the symptoms in question.

In order to determine the true probabilities of existence for the diagnoses Kᵢ′, the “true” numerical values for the a-priori probabilities are required. For this purpose, a basic quantity is defined, e.g. the number of emergency patients who were treated within a certain period of time due to heart problems by an emergency doctor. For a group of K′-elements, such as for the foursome grouping {K₁′, K₂′, K₃′, K₄′} concerning cardiac diagnoses, the “true” a-priori probabilities p(Kᵢ), i:=1, . . . , 4 can at least be approximated by counting the relative frequencies h(Kᵢ). The diagnoses calculated by the method presented are then valid when the p(Kᵢ) values obtained this way are used only for the case of the defined basic set.

In anticipation of future tasks, a clear improvement of the method can be achieved by using the events from the next higher level, i.e. the causes of the causative K′-elements. For example, the a-priori probability p(Kᵢ) is replaced by p (K₁|U₁₁ U₁₂ U₁₃) where the arbitrarily established set {U₁₁, U₁₂, U₁₃} includes the causes of Kᵢ. The investigation for possible causes of the K′-elements allows improved individualization of cases treated.

The desired calculation of the unknown x₁ is executed by the use of c₁: =p(Kᵢ) as follows:

$${x}_{1} := ( {K}_{1} \vert {F}_{11} … {F}_{16} {K}_{2}^{′} {K}_{3}^{′} {K}_{4}^{′} ) = \frac{1}{1 + \frac{p ( {F}_{11} … {F}_{16} \vert {\overline{K}}_{1} {K}_{2}^{′} {K}_{3}^{′} {K}_{4}^{′} ) p ( {\overline{K}}_{1} )}{p ( {F}_{11} … {F}_{16} \vert {K}_{1} {K}_{2}^{′} {K}_{3}^{′} {K}_{4}^{′} ) p ( {K}_{1} )}} = \frac{1}{1 + \frac{\begin{matrix}{a}_{10} {x}_{2} {x}_{3} {x}_{4} + {a}_{11} {x}_{2} {x}_{3} {\overline{x}}_{4} + {a}_{12} {x}_{2} {\overline{x}}_{3} {x}_{4} + {a}_{13} {x}_{2} {\overline{x}}_{3} {\overline{x}}_{4} + \\ + {a}_{14} {\overline{x}}_{2} {x}_{3} {x}_{4} + {a}_{15} {\overline{x}}_{2} {x}_{3} {\overline{x}}_{4} + {a}_{16} {\overline{x}}_{2} {\overline{x}}_{3} {x}_{4} + {a}_{17} {\overline{x}}_{2} {\overline{x}}_{3} {\overline{x}}_{4}\end{matrix}}{\begin{matrix}{b}_{10} {x}_{2} {x}_{3} {x}_{4} + {b}_{11} {x}_{2} {x}_{3} {\overline{x}}_{4} + {b}_{12} {x}_{2} {\overline{x}}_{3} {x}_{4} + {b}_{13} {x}_{2} {\overline{x}}_{3} {\overline{x}}_{4} + \\ + {b}_{14} {\overline{x}}_{2} {x}_{3} {x}_{4} + {b}_{15} {\overline{x}}_{2} {x}_{3} {\overline{x}}_{4} + {b}_{16} {\overline{x}}_{2} {\overline{x}}_{3} {x}_{4} + {b}_{17} {\overline{x}}_{2} {\overline{x}}_{3} {\overline{x}}_{4}\end{matrix}} ( \frac{{\overline{c}}_{1}}{{c}_{1}} )} . \\ AF ( 1 ) := \frac{{x}_{1}}{{c}_{1}} .$$

The equations for calculating the unknowns x₂, x₃ and x₄ are set up in exactly the same way. This gives a system of equations in four unknowns which is solved by means of a commercially available calculation program.

$$eq 1 := {x}_{1} = \frac{1}{1 + \frac{\begin{matrix}{a}_{10} {x}_{2} {x}_{3} {x}_{4} + {a}_{11} {x}_{2} {x}_{3} {\overline{x}}_{4} + {a}_{12} {x}_{2} {\overline{x}}_{3} {x}_{4} + {a}_{13} {x}_{2} {\overline{x}}_{3} {\overline{x}}_{4} + \\ {a}_{14} {\overline{x}}_{2} {x}_{3} {x}_{4} + {a}_{15} {\overline{x}}_{2} {x}_{3} {\overline{x}}_{4} + {a}_{16} {\overline{x}}_{2} {\overline{x}}_{3} {x}_{4} + {a}_{17} {\overline{x}}_{2} {\overline{x}}_{3} {\overline{x}}_{4}\end{matrix}}{\begin{matrix}{b}_{10} {x}_{2} {x}_{3} {x}_{4} + {b}_{11} {x}_{2} {x}_{3} {\overline{x}}_{4} + {b}_{12} {x}_{2} {\overline{x}}_{3} {x}_{4} + {b}_{13} {x}_{2} {\overline{x}}_{3} {\overline{x}}_{4} + \\ {b}_{14} {\overline{x}}_{2} {x}_{3} {x}_{4} + {b}_{15} {\overline{x}}_{2} {x}_{3} {\overline{x}}_{4} + {b}_{16} {\overline{x}}_{2} {\overline{x}}_{3} {x}_{4} + {b}_{17} {\overline{x}}_{2} {\overline{x}}_{3} {\overline{x}}_{4}\end{matrix}} ( \frac{{\overline{c}}_{1}}{{c}_{1}} )} ;$$

$$eq 2 := {x}_{2} = \frac{1}{1 + \frac{\begin{matrix}{a}_{20} {x}_{1} {x}_{3} {x}_{4} + {a}_{21} {x}_{1} {x}_{3} {\overline{x}}_{4} + {a}_{22} {x}_{1} {\overline{x}}_{3} {x}_{4} + {a}_{23} {x}_{1} {\overline{x}}_{3} {\overline{x}}_{4} + \\ {a}_{24} {\overline{x}}_{1} {x}_{3} {x}_{4} + {a}_{25} {\overline{x}}_{1} {x}_{3} {\overline{x}}_{4} + {a}_{26} {\overline{x}}_{1} {\overline{x}}_{3} {x}_{4} + {a}_{27} {\overline{x}}_{1} {\overline{x}}_{3} {\overline{x}}_{4}\end{matrix}}{\begin{matrix}{b}_{20} {x}_{1} {x}_{3} {x}_{4} + {b}_{21} {x}_{1} {x}_{3} {\overline{x}}_{4} + {b}_{22} {x}_{1} {\overline{x}}_{3} {x}_{4} + {b}_{23} {x}_{1} {\overline{x}}_{3} {\overline{x}}_{4} + \\ {b}_{24} {\overline{x}}_{1} {x}_{3} {x}_{4} + {b}_{25} {\overline{x}}_{1} {x}_{3} {\overline{x}}_{4} + {b}_{26} {\overline{x}}_{1} {\overline{x}}_{3} {x}_{4} + {b}_{27} {\overline{x}}_{1} {\overline{x}}_{3} {\overline{x}}_{4}\end{matrix}} ( \frac{{\overline{c}}_{2}}{{c}_{2}} )}$$

$$eq 3 := {x}_{3} = \frac{1}{1 + \frac{\begin{matrix}{a}_{30} {x}_{2} {x}_{1} {x}_{4} + {a}_{31} {x}_{2} {x}_{1} {\overline{x}}_{4} + {a}_{32} {x}_{2} {\overline{x}}_{1} {x}_{4} + {a}_{33} {x}_{2} {\overline{x}}_{1} {\overline{x}}_{4} + \\ {a}_{34} {\overline{x}}_{2} {x}_{1} {x}_{4} + {a}_{35} {\overline{x}}_{2} {x}_{1} {\overline{x}}_{4} + {a}_{36} {\overline{x}}_{2} {\overline{x}}_{1} {x}_{4} + {a}_{37} {\overline{x}}_{2} {\overline{x}}_{1} {\overline{x}}_{4}\end{matrix}}{\begin{matrix}{b}_{30} {x}_{2} {x}_{1} {x}_{4} + {b}_{31} {x}_{2} {x}_{1} {\overline{x}}_{4} + {b}_{32} {x}_{2} {\overline{x}}_{1} {x}_{4} + {b}_{33} {x}_{2} {\overline{x}}_{1} {\overline{x}}_{4} + \\ {b}_{34} {\overline{x}}_{2} {x}_{1} {x}_{4} + {b}_{35} {\overline{x}}_{2} {x}_{1} {\overline{x}}_{4} + {b}_{36} {\overline{x}}_{2} {\overline{x}}_{1} {x}_{4} + {b}_{37} {\overline{x}}_{2} {\overline{x}}_{1} {\overline{x}}_{4}\end{matrix}} ( \frac{{\overline{c}}_{3}}{{c}_{3}} )} ;$$

$$eq 4 := {x}_{4} = \frac{1}{1 + \frac{\begin{matrix}{a}_{40} {x}_{2} {x}_{3} {x}_{1} + {a}_{41} {x}_{2} {x}_{3} {\overline{x}}_{1} + {a}_{42} {x}_{2} {\overline{x}}_{3} {x}_{1} + {a}_{43} {x}_{2} {\overline{x}}_{3} {\overline{x}}_{1} + \\ {a}_{44} {\overline{x}}_{2} {x}_{3} {x}_{1} + {a}_{45} {\overline{x}}_{2} {x}_{3} {\overline{x}}_{1} + {a}_{46} {\overline{x}}_{2} {\overline{x}}_{3} {x}_{1} + {a}_{47} {\overline{x}}_{2} {\overline{x}}_{3} {\overline{x}}_{1}\end{matrix}}{\begin{matrix}{b}_{40} {x}_{2} {x}_{3} {x}_{1} + {b}_{41} {x}_{2} {x}_{3} {\overline{x}}_{1} + {b}_{42} {x}_{2} {\overline{x}}_{3} {x}_{1} + {b}_{43} {x}_{2} {\overline{x}}_{3} {\overline{x}}_{1} + \\ {b}_{44} {\overline{x}}_{2} {x}_{3} {x}_{1} + {b}_{45} {\overline{x}}_{2} {x}_{3} {\overline{x}}_{1} + {b}_{46} {\overline{x}}_{2} {\overline{x}}_{3} {x}_{1} + {b}_{47} {\overline{x}}_{2} {\overline{x}}_{3} {\overline{x}}_{1}\end{matrix}} ( \frac{{\overline{c}}_{4}}{{c}_{4}} )}$$

$$AF ( 1 ) := \frac{{x}_{1}}{{c}_{1}} ; AF ( 2 ) := \frac{{x}_{2}}{{c}_{2}} ; AF ( 3 ) := \frac{{x}_{3}}{{c}_{3}} ; AF ( 4 ) := \frac{{x}_{4}}{{c}_{4}} .$$

As an example, a complete and without modifications directly workable program for four unknowns is given below.

As an indicator of the presence or absence of an event from the set {Fᵢⱼ} we introduce the factor fᵢⱼ, with fᵢⱼ from {0,1}.

The coefficient a₁₀ serves as an example to illustrate the changes in aᵢₖ and bᵢₖ. As it has already been shown in the preceding description, a₁₀ was found to be:

$$\begin{matrix}p ( {F}_{11} \vert {\overline{K}}_{1} {K}_{2} {K}_{3} {K}_{4} ) := [ 1 - p ( {\overline{F}}_{11} \vert {K}_{2} ∼ ) \cdot \\ p ( {\overline{F}}_{11} \vert {K}_{3} ∼ ) \cdot p ( {\overline{F}}_{11} \vert {K}_{4} ∼ ) ] ; \\ ⋮ \\ p ( {F}_{16} \vert {\overline{K}}_{1} {K}_{2} {K}_{3} {K}_{4} ) := [ 1 - p ( {\overline{F}}_{16} \vert {K}_{2} ∼ ) \cdot \\ p ( {\overline{F}}_{16} \vert {K}_{3} ∼ ) \cdot p ( {\overline{F}}_{16} \vert {K}_{4} ∼ ) ] ; \\ {a}_{10} := p ( {F}_{11} \vert {\overline{K}}_{1} {K}_{2} {K}_{3} {K}_{4} ) \cdot … \cdot p ( {F}_{16} \vert {\overline{K}}_{1} {K}_{2} {K}_{3} {K}_{4} ) ;\end{matrix} .$$

In order to determine the possibility that elements from {F₁₁, . . . , F₁₆} are not present as symptoms, the factors fᵢⱼ are formed, so that from {F₁₁, . . . , F₁₆} the present or absent events can be marked using fᵢⱼ as follows:

If Fᵢⱼ is present as a symptom, then fᵢⱼ: =1.

If Fᵢⱼ is not present as a symptom, then fᵢⱼ: =0.

The indicators fᵢⱼ are the aᵢₖ and bᵢₖ supplements, changing the example a₁₀ to:

$$\begin{matrix}p ( {F}_{11} \vert {\overline{K}}_{1} {K}_{2} {K}_{3} {K}_{4} ) := [ 1 - p ( {\overline{F}}_{11} \vert {K}_{2} ∼ ) \cdot \\ p ( {\overline{F}}_{11} \vert {K}_{3} ∼ ) \cdot p ( {\overline{F}}_{11} \vert {K}_{4} ∼ ) ] ; \\ ⋮ \\ p ( {F}_{16} \vert {\overline{K}}_{1} {K}_{2} {K}_{3} {K}_{4} ) := [ 1 - p ( {\overline{F}}_{16} \vert {K}_{2} ∼ ) \cdot \\ p ( {\overline{F}}_{16} \vert {K}_{3} ∼ ) \cdot p ( {\overline{F}}_{16} \vert {K}_{4} ∼ ) ] ; \\ {a}_{10} := \\ [ {f}_{11} \cdot p ( {F}_{11} \vert {\overline{K}}_{1} {K}_{2} {K}_{3} {K}_{4} ) + ( 1 - {f}_{11} ) \cdot ( 1 - p ( {F}_{11} \vert {\overline{K}}_{1} K {K}_{3} {K}_{4} ) ] \cdot \\ ⋮ \\ \cdot [ {f}_{16} \cdot p ( {F}_{16} \vert {\overline{K}}_{1} {K}_{2} {K}_{3} {K}_{4} ) + ( 1 - {f}_{16} ) \cdot ( 1 - p ( {F}_{16} \vert {\overline{K}}_{1} {K}_{2} {K}_{3} {K}_{4} ) ] .\end{matrix}$$

These factors fᵢⱼ are to be attached to all aᵢₖ and bᵢₖ.

It follows the announced complete and fully workable example which was built on the basis of Table 1, 2 and 3. This in great detail presented example may serve as a defining example.

1. A computer-implemented universal method that can be used in numerous areas of knowledge, for example, earthquake research, geological prospecting, criminal forensics, aircraft accident investigation, on-board diagnostics in road cars and aircraft, monitoring of sea-based electricity generators, and in medicine, in the latter case amongst other things for the evaluation of electrocardiograms; the method is applicable in all tasks where several hypotheses stand for selection and the most likely candidate will be determined by the symptoms (observed or missing although expected), the surrounding hypotheses, and—according to need—the inhibitors; the invention is characterized by an algebraic method which works on four competing diagnoses Kᵢ′, i:=1, . . . , 4 and calculates for each one of them the appreciation factor AF(i) and the a-posteriori probability xᵢ, with the highest upgrading factor determining the correct diagnosis; every Kᵢ′ is affiliated with a set of follow events (Fᵢⱼ, j:=1, . . . , 6) with the properties that each event from {Fᵢⱼ} is the follow event of at least two diagnoses, that the elements in the set {Kᵢ′, i:=1, . . . , 4} are stochastically independent and stochastically self-reliant and that {Kᵢ′, i:=1, . . . , 4} contains either all causes of the Fᵢⱼ or is supplemented by additional Kᵢ in negated form; all together enables the formation of the following equations:
x₁:=p(K₁|F₁₁ . . . F₁₆K₂′K₃′K₄′),
x₂:=p(K₂|F₂₁ . . . F₂₆K₁′K₃′K₄′),
x₃:=p(K₃|F₃₁ . . . F₃₆K₂′K₁′K₄′),
x₄:=p(K₄|F₄₁ . . . F₄₆K₂′K₃′K₁′),
which get a transformation into
$${x}_{i} := \frac{1}{1 + \frac{{Z}_{i}}{{N}_{i}} \cdot \frac{p ( {\overline{K}}_{i} )}{p ( {K}_{i} )}} ,$$
i:=1, . . . ,4, with
Z₁:=p(F₁₁ . . . F₁₆| K̅₁′K₂′K₄′) and N₁:=p(F₁₁ . . . F₁₆|K₁K₂′K₃′K₄′),
Z₂:=p(F₂₁ . . . F₂₆| K̅₂K₁′K₃′K₄′) and N₂:=p(F₂₁. . . F₂₆|K₂K₁′K₃′K₄′),
Z₃:=p(F₃₁ . . . F₃₆| K̅₃K₂′K₁′K₄′) and N₃:=p(F₃₁ . . . F₃₆|K₃K₂′K₁′K₄′),
Z₄=p(F₄₁ . . . F₄₆| K̅₄K₂′K₃′K₁′) and N₄:=p(F₄₁ . . . F₄₆|K₄K₂′K₃′K₁′),
whereby the Zᵢ and Nᵢ are subjected to a linear interpolation, so that for e.g. Z₁ goes on in
$$p ( {F}_{11} … {F}_{16} \vert {\overline{K}}_{1} {K}_{2}^{′} {K}_{3}^{′} {K}_{4}^{′} ) = p ( {F}_{11} … {F}_{16} \vert {\overline{K}}_{1} {K}_{2} {K}_{3} {K}_{4} ) \cdot {x}_{2} \cdot {x}_{3} \cdot {x}_{4} + ( {F}_{11} … {F}_{16} \vert {\overline{K}}_{1} {K}_{2} {K}_{3} {\overline{K}}_{4} ) \cdot {x}_{2} \cdot {x}_{3} \cdot \overline{x} + p ( {F}_{11} … {F}_{16} \vert {\overline{K}}_{1} {K}_{2} {\overline{K}}_{3} {K}_{4} ) \cdot {x}_{2} \cdot {\overline{x}}_{3} \cdot {x}_{4} + p ( {F}_{11} … {F}_{16} \vert {\overline{K}}_{1} {K}_{2} {\overline{K}}_{3} {\overline{K}}_{4} ) \cdot {x}_{2} \cdot {\overline{x}}_{3} \cdot {\overline{x}}_{4} + p ( {F}_{11} … {F}_{16} \vert {\overline{K}}_{1} {\overline{K}}_{2} {K}_{3} {K}_{4} ) \cdot {\overline{x}}_{2} \cdot {x}_{3} \cdot {x}_{4} + p ( {F}_{11} … {F}_{16} \vert {\overline{K}}_{1} {\overline{K}}_{2} {K}_{3} {\overline{K}}_{4} ) \cdot {\overline{x}}_{2} \cdot {x}_{3} \cdot {\overline{x}}_{4} + p ( {F}_{11} … {F}_{16} \vert {\overline{K}}_{1} {\overline{K}}_{2} {\overline{K}}_{3} {K}_{4} ) \cdot {\overline{x}}_{2} \cdot {\overline{x}}_{3} \cdot {x}_{4} + p ( {F}_{11} … {F}_{16} \vert {\overline{K}}_{1} {\overline{K}}_{2} {\overline{K}}_{3} {\overline{K}}_{4} ) \cdot {\overline{x}}_{2} \cdot {\overline{x}}_{3} \cdot {\overline{x}}_{4} ,$$
and wherein for the conditional probabilities present in such interpolations, the designations aᵢₖ and bᵢₖ are chosen, k:=0, . . . , 7, in detail aᵢₖ for the interpolations of Zᵢ and bᵢₖ for the interpolations of Nᵢ, in a manner that, for example, the first factor in the equation above will be replaced by a₁₀ with
a₁₀:=p(F₁₁ . . . F₁₆| K̅₁K₂K₃K₄);
using cᵢ:=p(Kᵢ), a system of equations in the four unknowns xᵢ
$${x}_{1} = \frac{1}{1 + \frac{{a}_{10} {x}_{2} {x}_{3} {x}_{4} + {a}_{11} {x}_{2} {x}_{3} {\overline{x}}_{4} + {a}_{12} {x}_{2} {\overline{x}}_{3} {x}_{4} + {a}_{13} {x}_{2} {\overline{x}}_{3} {\overline{x}}_{4} + {a}_{14} {\overline{x}}_{2} {x}_{3} {x}_{4} + {a}_{15} {\overline{x}}_{2} {x}_{3} {\overline{x}}_{4} + {a}_{16} {\overline{x}}_{2} {\overline{x}}_{3} {x}_{4} + {a}_{17} {\overline{x}}_{2} {\overline{x}}_{3} {\overline{x}}_{4}}{{b}_{10} {x}_{2} {x}_{3} {x}_{4} + {b}_{11} {x}_{2} {x}_{3} {\overline{x}}_{4} + {b}_{12} {x}_{2} {\overline{x}}_{3} {x}_{4} + {b}_{13} {x}_{2} {\overline{x}}_{3} {\overline{x}}_{4} + {b}_{14} {\overline{x}}_{2} {x}_{3} {x}_{4} + {b}_{15} {\overline{x}}_{2} {x}_{3} {\overline{x}}_{4} + {b}_{16} {\overline{x}}_{2} {\overline{x}}_{3} {x}_{4} + {b}_{17} {\overline{x}}_{2} {\overline{x}}_{3} {\overline{x}}_{4}} ( \frac{{\overline{c}}_{1}}{{c}_{1}} )}$$
$${x}_{2} = \frac{1}{1 + \frac{{a}_{20} {x}_{1} {x}_{3} {x}_{4} + {a}_{21} {x}_{1} {x}_{3} {\overline{x}}_{4} + {a}_{22} {x}_{1} {\overline{x}}_{3} {x}_{4} + {a}_{23} {x}_{1} {\overline{x}}_{3} {\overline{x}}_{4} + {a}_{24} {\overline{x}}_{1} {x}_{3} {x}_{4} + {a}_{25} {\overline{x}}_{1} {x}_{3} {\overline{x}}_{4} + {a}_{26} {\overline{x}}_{1} {\overline{x}}_{3} {x}_{4} + {a}_{27} {\overline{x}}_{1} {\overline{x}}_{3} {\overline{x}}_{4}}{{b}_{20} {x}_{1} {x}_{3} {x}_{4} + {b}_{21} {x}_{1} {x}_{3} {\overline{x}}_{4} + {b}_{22} {x}_{1} {\overline{x}}_{3} {x}_{4} + {b}_{23} {x}_{1} {\overline{x}}_{3} {\overline{x}}_{4} + {b}_{24} {\overline{x}}_{1} {x}_{3} {x}_{4} + {b}_{25} {\overline{x}}_{1} {x}_{3} {\overline{x}}_{4} + {b}_{26} {\overline{x}}_{1} {\overline{x}}_{3} {x}_{4} + {b}_{27} {\overline{x}}_{1} {\overline{x}}_{3} {\overline{x}}_{4}} ( \frac{{\overline{c}}_{2}}{{c}_{2}} )}$$
$${x}_{3} = \frac{1}{1 + \frac{{a}_{30} {x}_{2} {x}_{1} {x}_{4} + {a}_{31} {x}_{2} {x}_{1} {\overline{x}}_{4} + {a}_{32} {x}_{2} {\overline{x}}_{1} {x}_{4} + {a}_{33} {x}_{2} {\overline{x}}_{1} {\overline{x}}_{4} + {a}_{34} {\overline{x}}_{2} {x}_{1} {x}_{4} + {a}_{35} {\overline{x}}_{2} {x}_{1} {\overline{x}}_{4} + {a}_{36} {\overline{x}}_{2} {\overline{x}}_{1} {x}_{4} + {a}_{37} {\overline{x}}_{2} {\overline{x}}_{1} {\overline{x}}_{4}}{{b}_{30} {x}_{2} {x}_{1} {x}_{4} + {b}_{31} {x}_{2} {x}_{1} {\overline{x}}_{4} + {b}_{32} {x}_{2} {\overline{x}}_{1} {x}_{4} + {b}_{33} {x}_{2} {\overline{x}}_{1} {\overline{x}}_{4} + {b}_{34} {\overline{x}}_{2} {x}_{1} {x}_{4} + {b}_{35} {\overline{x}}_{2} {x}_{1} {\overline{x}}_{4} + {b}_{36} {\overline{x}}_{2} {\overline{x}}_{1} {x}_{4} + {b}_{37} {\overline{x}}_{2} {\overline{x}}_{1} {\overline{x}}_{4}} ( \frac{{\overline{c}}_{3}}{{c}_{3}} )}$$
$${x}_{4} = \frac{1}{1 + \frac{{a}_{40} {x}_{2} {x}_{3} {x}_{1} + {a}_{41} {x}_{2} {x}_{3} {\overline{x}}_{1} + {a}_{42} {x}_{2} {\overline{x}}_{3} {x}_{1} + {a}_{43} {x}_{2} {\overline{x}}_{3} {\overline{x}}_{1} + {a}_{44} {\overline{x}}_{2} {x}_{3} {x}_{1} + {a}_{45} {\overline{x}}_{2} {x}_{3} {\overline{x}}_{1} + {a}_{46} {\overline{x}}_{2} {\overline{x}}_{3} {x}_{1} + {a}_{47} {\overline{x}}_{2} {\overline{x}}_{3} {\overline{x}}_{1}}{{b}_{40} {x}_{2} {x}_{3} {x}_{1} + {b}_{41} {x}_{2} {x}_{3} {\overline{x}}_{1} + {b}_{42} {x}_{2} {\overline{x}}_{3} {x}_{1} + {b}_{43} {x}_{2} {\overline{x}}_{3} {\overline{x}}_{1} + {b}_{44} {\overline{x}}_{2} {x}_{3} {x}_{1} + {b}_{45} {\overline{x}}_{2} {x}_{3} {\overline{x}}_{1} + {b}_{46} {\overline{x}}_{2} {\overline{x}}_{3} {x}_{1} + {b}_{47} {\overline{x}}_{2} {\overline{x}}_{3} {\overline{x}}_{1}} ( \frac{{\overline{c}}_{4}}{{c}_{4}} )}$$
results, wherein for all Kᵢ′ equiprobability with p(Kᵢ):=0.25 is first assumed; in order to get the aᵢₖ and bᵢₖ—by using the conditional stochastic independence of the F-elements—a factorization with respect to the F-elements is carried out, for example as
a₁₀:=p(F₁₁| K̅₁K₂K₃K₄)· . . . ·p(F₁₆| K̅₁K₂K₃K₄);
a further factorization of the emerging conditional probabilities is performed—taking into account the stochastic self-reliance of the Kᵢ—for example
p(F₁₁| K̅₁K₂K₃K₄)=[1−p( F̅₁₁|K₂˜)·p( F̅₁₁|K₃˜)·p( F̅₁₁|K₄˜)],
wherein the tilde symbol denotes a product of events (synonymous: compound of events, logic product) which apart from the Kᵢ entered before the tilde contains all competing diagnoses in negated form, and wherein the statement p(Fᵢⱼ|Kᵢ˜)=0 is true, if Fᵢⱼ is no follow event of Kᵢ; in order to carry out the calculation we introduce factors fᵢⱼ with fᵢⱼ:=1, if Fᵢⱼ is present as a symptom, and fᵢⱼ:=0, if Fᵢⱼ is not present as a symptom, so that in the example chosen we get for a₁₀ the form
$${a}_{10} := [ {f}_{11} \cdot p ( {F}_{11} \vert {\overline{K}}_{1} {K}_{2} {K}_{3} {K}_{4} ) + ( 1 - {f}_{11} ) \cdot ( 1 - p ( {F}_{11} \vert {\overline{K}}_{1} {K}_{2} {K}_{3} {K}_{4} ) ] \cdot \\ ⋮ \\ \cdot [ {f}_{16} \cdot p ( {F}_{16} \vert {\overline{K}}_{1} {K}_{2} {K}_{3} {K}_{4} ) + ( 1 - {f}_{16} ) \cdot ( 1 - p ( {F}_{16} \vert {\overline{K}}_{1} {K}_{2} {K}_{3} {K}_{4} ) ] ;$$
with this method a system of four nonlinear equations with the four unknowns xᵢ is obtained, which will be solved by a commercial calculation program providing the numerical values of the xᵢ and consequently the numerical values of the
$$AF ( i ) := \frac{{x}_{i}}{p ( {K}_{i} )} .$$

2. A method as in claim 1, with the difference that now only three competing diagnoses Kᵢ′, i: =1, . . . , 3 are considered with all other diagnoses being considered in negated form, with the resulting difference that the evaluation equations
x₁:=p(K₁|F₁₁ . . . F₁₆K₂′K₃′ K̅₄),
x₂:=p(K₂|F₂₁ . . . F₂₆K₁′K₃′ K̅₄),
x₃:=p(K₃|F₃₁ . . . F₃₆K₂′K₁′ K̅₄),
now apply, which after a transformation merge into
$${x}_{i} := \frac{1}{1 + \frac{{Z}_{i}}{{N}_{i}} \cdot \frac{p ( {\overline{K}}_{i} )}{p ( {K}_{i} )}} ,$$
i:=1, . . . ,3, with
Z₁:=p(F₁₁ . . . F₁₆| K̅₁K₂′K₃′ K̅₄) and N₁:=p(F₁₁ . . . F₁₆|K₁K₂′K₃′ K̅₄),
Z₂:=p(F₂₁ . . . F₂₆| K̅₂K₁′K₃′ K̅⁴) and N₂:=p(F₂₁ . . . F₂₆|K₂K₁′K₃′ K̅₄),
Z₃:=p(F₃₁ . . . F₃₆| K̅₃K₂′K₁′ K̅₄) and N₃:=p(F₃₁ . . . F₃₆|K₃K₂′K₁′ K̅₄),
wherein the further procedure is as in claim 1, with the difference that the equations
$${x}_{1} = \frac{1}{1 + \frac{{a}_{10} {x}_{2} {x}_{3} + {a}_{11} {x}_{2} {\overline{x}}_{3} ++ {a}_{12} {\overline{x}}_{2} {x}_{3} + {a}_{13} {\overline{x}}_{2} {\overline{x}}_{3}}{{b}_{10} {x}_{2} {x}_{3} + {b}_{11} {x}_{2} {\overline{x}}_{3} ++ {b}_{12} {\overline{x}}_{2} {x}_{3} + {b}_{13} {\overline{x}}_{2} {\overline{x}}_{3}} ( \frac{{\overline{c}}_{1}}{{c}_{1}} )} , \\ {x}_{2} = \frac{1}{1 + \frac{{a}_{20} {x}_{1} {x}_{3} + {a}_{21} {x}_{1} {\overline{x}}_{3} + {a}_{22} {\overline{x}}_{1} {x}_{3} + {a}_{23} {\overline{x}}_{1} {\overline{x}}_{3}}{{b}_{20} {x}_{1} {x}_{3} + {b}_{21} {x}_{1} {\overline{x}}_{3} + {b}_{22} {\overline{x}}_{1} {x}_{3} + {b}_{23} {\overline{x}}_{1} {\overline{x}}_{3}} ( \frac{{\overline{c}}_{2}}{{c}_{2}} )} , \\ {x}_{3} = \frac{1}{1 + \frac{{a}_{30} {x}_{2} {x}_{1} + {a}_{31} {x}_{2} {\overline{x}}_{1} + {a}_{32} {\overline{x}}_{2} {x}_{1} + {a}_{33} {\overline{x}}_{2} {\overline{x}}_{1}}{{b}_{30} {x}_{2} {x}_{1} + {b}_{31} {x}_{2} {\overline{x}}_{1} + {b}_{32} {\overline{x}}_{2} {x}_{1} + {b}_{33} {\overline{x}}_{2} {\overline{x}}_{1}} ( \frac{{\overline{c}}_{3}}{{c}_{3}} )} ,$$
result, whereby for all Kᵢ′ an equiprobability with p(Kᵢ): =0.33, i: =1, . . . ,3 is assumed, and whereby for each xᵢ in turn aᵢₖ and bᵢₖ, k:=0, . . . , 3 are elaborated, depending on the expressions to be interpolated, so that using this method a system of three equations is obtained with the three unknowns xᵢ.

3. A method as in claims 1 and 2, with the difference that now only two competing diagnoses Kᵢ′, i: =1, . . . , 2 are considered, and all other diagnoses are considered in negated form, with the consequential difference that the evaluation equations
x₁:=p(K₁|F₁₁ . . . F₁₆K₂′ K̅₃ K̅₄)
x₂:=p(K₂|F₂₁ . . . F₂₆K₁′ K̅₃ K̅₄)
now apply, which after transformation merge into
$${x}_{i} := \frac{1}{1 + \frac{{Z}_{i}}{{N}_{i}} \cdot \frac{p ( {\overline{K}}_{i} )}{p ( {K}_{i} )}} ,$$
i:=1, . . . ,2, with
Z₁:=p(F₁₁ . . . F₁₆| K̅₁K₂′ K̅₃ K̅₄) and N₁:=p(F₁₁ . . . F₁₆|K₁K₂′ K̅₃ K̅₄),
Z₂:=p(F₂₁ . . . F₂₆| K̅₂K₁′ K̅₃ K̅₄) and N₂:=p(F₂₁ . . . F₂₆|K₂K₁′ K̅₃ K̅₄),
wherein the procedure is followed as in claims 1 and 2, with the difference that the equations
$${x}_{1} = \frac{1}{1 + \frac{{a}_{10} {x}_{2} + {a}_{11} {\overline{x}}_{2}}{{b}_{10} {x}_{2} + {b}_{11} {\overline{x}}_{2}} ( \frac{{\overline{c}}_{1}}{{c}_{1}} )} , \\ {x}_{2} = \frac{1}{1 + \frac{{a}_{20} {x}_{1} + {a}_{21} {\overline{x}}_{1}}{{b}_{20} {x}_{1} + {b}_{21} {\overline{x}}_{1}} ( \frac{{\overline{c}}_{2}}{{c}_{2}} )} ,$$
result, whereby initially for all Kᵢ′ an equiprobability p(Kᵢ)=0.5, i: =1, . . . , 2 is assumed, and whereby for each xᵢ in turn aᵢₖ and bᵢₖ, k:=0, . . . ,1 are elaborated, depending on the expressions to be interpolated, so that with this method a system of two equations is obtained with the two unknowns xᵢ.

4. A method as in claims 1, 2 and 3, with the difference that now the aᵢₖ and bᵢₖ are not set when the linear interpolation of the Zᵢ and Nᵢ has taken place, but rather that they arise directly from the Zᵢ and Nᵢ following a schematic procedure which is to be used especially where there are five or more apostrophized diagnoses; the scheme will be illustrated by using
p(F₁₁ . . . F₁₆| K̅₁K₂′K₃′K₄′)
as an example, wherein as a first step for an arbitrary coefficient aᵢₖ, for example a₁₄, the second digit standing in the index (here we have k=4) is written in binary (100), and wherein in a second step, the binary number is projected right-aligned onto the apostrophized elements, as in the example 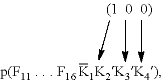
whereby the apostrophes are then omitted, and the digits “1” of the binary numbers indicate the negations to be carried out which leads to
a₁₄:=(F₁₁ . . . F₁₆| K̅₁ K̅₂K₃K₄);
in a third step it follows a factorization with respect to the F-elements
p(F₁₁ . . . F₁₆| K̅₁ K̅₂K₃K₄)=p(F₁₁| K̅₁ K̅₂K₃K₄)· . . . ·p(F₁₆| K̅₁ K̅₂K₃K₄)
and a factorization with respect to the K-elements
p(F₁₁ . . . F₁₆| K̅₁ K̅₂K₃K₄):=[1−p( F̅₁₁|K₃˜)·p( F̅₁₁|K₄˜)]· . . . ·[1−p( F̅₁₆|K₃˜)˜p( F̅₁₆|K₄˜)];
the fourth step deals with the product of unknowns which belongs to a₁₄ whereby the individual elements of the product have the same negations and indices as those obtained in Step 2, i.e. the projection is continued directly to 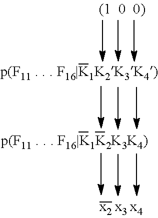
determining x̅₂·x₃·x₄ as the product of unknowns associated with the coefficient a₁₄ thereby obtaining as result
a₁₄ x̅₂x₃x₄=[1−p( F̅₁₁|K₃ . . . )·p( F̅₁₁|K₄ . . . )]· . . . ·[1−p( F̅₁₆|K₃ . . . )·p( F̅₁₆|K₄ . . . )]· x̅₂x₃x₄.

5. A method as in claims 1 to 4, wherein five or more competing diagnoses Kᵢ′ and any number of other diagnoses in negated form are considered, and wherein for each additional apostrophized diagnosis the members in {aᵢₖ} and {bᵢₖ} are each doubled, for example, there is k:=0, . . . , 15 for five and k:=0, . . . , 31 for six apostrophized diagnoses, so that systems of five or more equations with five or more unknowns xᵢ arise.

6. A method as in claims 1 to 5 with the addition that for any particular Kᵢ′-grouping, and in order to achieve an orderly and clear procedure, a tabular arrangement of the following layout is used, wherein
all symptoms to be considered are recorded in the first column, and wherein
one column is created for each diagnosis, and wherein
all follow events arising from a diagnosis are entered in the column associated with that diagnosis together with their p(Fᵢⱼ|Kᵢ˜) numerical values, and wherein
it is laid out in such a way that identical follow events, i.e. events with a different Fᵢⱼ indexing, but the same symptom affiliation, stand in a single row.

7. A method as in claims 1 to 6 with the difference that for any particular Kᵢ′ the number of associated follow events is not strictly set to j:=6, but in which the number of follow events is freely selectable and unlimited.

8. A method as in claims 1 to 7 with the difference that for the diagnoses Kᵢ the a-priori probabilities p(Kᵢ) are not assumed to be equal, and that for cᵢ:=p(Kᵢ) the actual “true” a-priori probability—generally determined stochastically—is used, whereby on the basis of the calculated final result it must be decided whether the highest AF(i) or the highest xᵢ indicates the correct diagnosis, so that in the case of a non-agreement an option can be taken by changing cᵢ:=p(Kᵢ) to cᵢ:=p(Kᵢ|Uᵢ₁ Uᵢ₂ . . . ) for any Kᵢ′ and arbitrarily chosen {Uᵢ₁, Uᵢ₂ . . . } wherein the latter are the causes of the causative events Kᵢ′, and so that in the case of a continuing non-agreement the highest xᵢ will determine the correct diagnosis.

9. A method as in claims 1 to 8, with the difference that the a-priori probabilities p(Kᵢ) are not used if the causes of the causative events Kᵢ′ can be considered, and that with additional consideration of any number of freely selectable causes, e.g. the arbitrarily chosen causes Uᵢ₁ to Uᵢ₄ of any Kᵢ′, an improvement in reliability is achieved simply by replacing the previously used
$${c}_{i} := p ( {K}_{i} )$$
$$with$$
$${c}_{i} := p ( {K}_{i} \vert {U}_{i 1} )$$
$$or$$
$${c}_{i} := p ( {K}_{i} \vert {U}_{i 1} {U}_{i 2} ) = 1 - \frac{p ( {\overline{K}}_{i} \vert {U}_{i 1} {\overline{U}}_{i 2} ) \cdot p ( {\overline{K}}_{i} \vert {\overline{U}}_{i 1} {U}_{i 2} )}{p ( {\overline{K}}_{i} \vert {\overline{U}}_{i 1} {\overline{U}}_{i 2} )}$$
$$or$$
$${c}_{i} := p ( {K}_{i} \vert {U}_{i 1} {U}_{i 2} {U}_{i 3 } ) = 1 - \frac{p ( {\overline{K}}_{i} \vert {U}_{i 1} {\overline{U}}_{i 2} {\overline{U}}_{i 3} ) \cdot p ( {\overline{K}}_{i} \vert {\overline{U}}_{i 1} {U}_{i 2} {\overline{U}}_{i 3} ) \cdot p ( {\overline{K}}_{i} \vert {U}_{i 1} {\overline{U}}_{i 2} {U}_{i 3} )}{{p ( {\overline{K}}_{i} \vert {U}_{i 1} {\overline{U}}_{i 2} {\overline{U}}_{i 3} )}^{2}}$$
$$or$$
$${c}_{i} := p ( {K}_{i} \vert {U}_{i 1} {U}_{i 2} {U}_{i 3} {U}_{i 4} ) = 1 - \frac{\begin{matrix}p ( {\overline{K}}_{i} \vert {U}_{i 1} {\overline{U}}_{i 2} {\overline{U}}_{i 3} {\overline{U}}_{i 4} ) \cdot p ( {\overline{K}}_{i} \vert {\overline{U}}_{i 1} {U}_{i 2} {\overline{U}}_{i 3} {\overline{U}}_{i 4} ) \cdot \\ p ( {\overline{K}}_{i} \vert {\overline{U}}_{i 1} {\overline{U}}_{i 2} {U}_{i 3} {\overline{U}}_{i 4} ) \cdot p ( {\overline{K}}_{i} \vert {\overline{U}}_{i 1} {\overline{U}}_{i 2} {\overline{U}}_{i 3} {U}_{i 4} )\end{matrix}}{{p ( {\overline{K}}_{i} \vert {\overline{U}}_{i 1} {\overline{U}}_{i 2} {\overline{U}}_{i 3} {\overline{U}}_{i 4} )}^{3}} ,$$
whereby Uᵢ₁ to Uᵢ₄ must be stochastically independent, whereby any K′-element, e.g. K₁′, separates the causes of K₁′ from the follow events of K₁′, and whereby in the final outcome the highest xᵢ determines the correct diagnosis.

10. A method as in claim 9 with the difference that with any Kᵢ′ the arbitrarily chosen causes Uᵢ₁ to Uᵢ₄ are linked with their respectively associated inhibitors I, i.e. that any Uᵢ₁ forms a logic product with its inhibitory events I_{U}_{ᵢ₁}_{→K}_{ᵢ}, which inhibit the causal pathway Uᵢ₁→Kᵢ with a probability 0<p<1, and that such a logic “event & inhibitors product”, e.g. (Uᵢ₁I_{U}_{ᵢ₁}_{→K}_{ᵢ}), occurs in place of the non-negated Uᵢ₁, e.g. in
$${c}_{i} := p ( {K}_{i} \vert {U}_{i 1} {U}_{i 2} ) = 1 - \frac{p ( {\overline{K}}_{i} \vert {U}_{i 1} {I}_{{U}_{i 1} \to {K}_{i}} {\overline{U}}_{i 2} ) \cdot p ( {\overline{K}}_{i} \vert {\overline{U}}_{i 1} {U}_{i 2} )}{p ( {\overline{K}}_{i} \vert {\overline{U}}_{i 1} {\overline{U}}_{i 2} )} ,$$
so that in this way an improvement in the reliability and selectivity is achieved simply by expanding the non-negated Uᵢ in the expressions for determining the cᵢ, with the requirement that the events from the union of the U-elements and the I-elements are stochastically independent.

11. A method as in claims 1 to 10, with the difference that now the Kᵢ′ are linked with their respectively associated inhibitors J, i.e. that for an arbitrarily selected probability, e.g. for p(F₁₆|K₃˜), the element K₃ forms a logic product with its inhibitory events J_{K}_{₃}_{→F}_{₁₆} that inhibit the causal pathway K₃→F₁₆ with a probability 0<p<1, and that such a logic product, e.g. (K₃J_{K}_{₃}_{→F}_{₁₆}_{#1}J_{K}_{₃}_{→F}_{₁₆}_{#2}), replaces the non-negated event K₃ which leads to p(F₁₆|K₃J_{K}_{₃}_{→F}_{₁₆}_{#1}J_{K}_{₃}_{→F}_{₁₆}_{#2}), whereby #1 and #2 merely represent a serial numbering where there is more than one inhibitor, and that in such a way an improvement in reliability is achieved simply by expanding the condition within the probabilities of the form p(Fᵢⱼ|Kᵢ˜), with the requirement that the events from the union of the K-elements and the J-elements are stochastically independent.

94. A method as in claim 1, with the difference that in the case of two or more inhibitors of a causal pathway, e.g. K₃→F₁₆, a factorization may be used with respect to the inhibitors, which is carried out using a simple template, e.g.
$$p ( {F}_{16} \vert {K}_{3} {J}_{{K}_{3} \to {F}_{16} \#1} {J}_{{K}_{3} \to {F}_{16} \#2} {J}_{{K}_{3} \to {F}_{16} \#3} ∼ ) := \frac{p ( {F}_{16} \vert {K}_{3} {J}_{{K}_{3} \to {F}_{16} \#1} ∼ ) \cdot p ( {F}_{16} \vert {K}_{3} {J}_{{K}_{3} \to {F}_{16} \#2} ∼ ) \cdot p ( {F}_{16} \vert {K}_{3} {J}_{{K}_{3} \to {F}_{16} \#3} ∼ )}{{[ p ( {F}_{16} \vert {K}_{3} ∼ ) ]}^{s - 1}} ,$$
where “s” is the number of inhibitors of the causal pathway K₃→F₁₆, having regard to the requirements that no hidden causes of F₁₆ exist, and that the inhibitors of the causal pathway K₃→F₁₆ are stochastically self-reliant causes of the event ( K̅₃̅→̅K̅₁̅₆̅).

13. A method as in claims 1 to 12, with the difference that now the expressions of the form p(Fᵢⱼ|K₁ . . . Kₜ)—where “t” is a natural integer and the Kᵢ may occur also negated—get a factorization with respect to the Kᵢ in a different kind of way considering hidden causes, stemming from the possibility that diagnoses outside of the fixed set of Kᵢ′-elements may exist, coming into consideration as causing a single Fᵢⱼ, so that e.g. the expressions p(F₁₁|K₁ K₂ K₃ K₄), p(F₁₁|K₁ K₂ K₃ K̅₄), p(F₁₁|K₁ K₂ K̅₃ K̅₄) can be factorized into
$$p ( {F}_{11} \vert {K}_{1} {K}_{2} {K}_{3} {K}_{4} ) = 1 - \frac{\begin{matrix}p ( {\overline{F}}_{11} \vert {K}_{1} {\overline{K}}_{2} {\overline{K}}_{3} {\overline{K}}_{4} ) \cdot p ( {\overline{F}}_{11} \vert {\overline{K}}_{1} {K}_{2} {\overline{K}}_{3} {\overline{K}}_{4} ) \cdot \\ p ( {\overline{F}}_{11} \vert {\overline{K}}_{1} {\overline{K}}_{2} {K}_{3} {\overline{K}}_{4} ) \cdot p ( {\overline{F}}_{11} \vert {\overline{K}}_{1} {\overline{K}}_{2} {\overline{K}}_{3} {K}_{4} )\end{matrix}}{{( p ( {\overline{F}}_{11} \vert {\overline{K}}_{1} {\overline{K}}_{2} {\overline{K}}_{3} {\overline{K}}_{4} ) )}^{3}} , \\ p ( {F}_{11} \vert {K}_{1} {K}_{2} {K}_{3} {\overline{K}}_{4} ) = 1 - \frac{\begin{matrix}p ( {\overline{F}}_{11} \vert {K}_{1} {\overline{K}}_{2} {\overline{K}}_{3} {\overline{K}}_{4} ) \cdot p ( {\overline{F}}_{11} \vert {\overline{K}}_{1} {K}_{2} {\overline{K}}_{3} {\overline{K}}_{4} ) \cdot \\ p ( {\overline{F}}_{11} \vert {\overline{K}}_{1} {\overline{K}}_{2} {K}_{3} {\overline{K}}_{4} ) \cdot p ( {\overline{F}}_{11} \vert {\overline{K}}_{1} {\overline{K}}_{2} {K}_{3} {\overline{K}}_{4} )\end{matrix}}{{( p ( {\overline{F}}_{11} \vert {\overline{K}}_{1} {\overline{K}}_{2} {\overline{K}}_{3} {\overline{K}}_{4} ) )}^{2}} , \\ p ( {F}_{11} \vert {K}_{1} {K}_{2} {\overline{K}}_{3} {\overline{K}}_{4} ) = 1 - \frac{p ( {\overline{F}}_{11} \vert {K}_{1} {\overline{K}}_{2} {\overline{K}}_{3} {\overline{K}}_{4} ) \cdot p ( {\overline{F}}_{11} \vert {\overline{K}}_{1} {K}_{2} {\overline{K}}_{3} {\overline{K}}_{4} )}{( p ( {\overline{F}}_{11} \vert {\overline{K}}_{1} {\overline{K}}_{2} {\overline{K}}_{3} {\overline{K}}_{4} ) )} ,$$
whereby in contrast to claims 1 to 12 p(F₁₁| K̅₁ K̅₂ K̅₃ K̅₄) is not zero.

95. A method as in claims 1 to 13, with the difference that now the numerical values of the probabilities p(Fᵢ_{₀}ⱼ|Kᵢ_{₀}˜) do not remain unchanged, but that after a diagnosis Kᵢ_{₀} which is found to be a correct diagnosis, the probability p(Fᵢ_{₀}ⱼ|Kᵢ_{₀}˜) is subject to a revision so that a new value is entered in the procedure, in such a way that e.g.
p(F₁₆|K₁˜)=68/100=0.6800
in the case that K₁ is confirmed to be present and F₁₆ is confirmed to be present—goes on in
p(F₁₆|K₁˜)=69/101=0.6832 and
in the case that K₁ is confirmed to be present and F₁₆ is not present—goes on in
p(F₁₆|Kᵢ˜)=68/101=0.6733;
also subject to a revision are the p(Kᵢ) in such a way that e.g.
p(Kᵢ)=150/1000=0.1500
in the case that K₁ is confirmed to be present—receives the new value
p(Kᵢ)=151/1001=0.1508 and
in the case K₁ is confirmed to be not present—it receives the new value
p(Kᵢ)=150/1001=0.1499,
all to be done on the fly or after collection over any period.
